(19) United States
(12) Patent Application Publication
(10) Pub. No.: US 2022/0046922 A1
(43) Pub. Date: Feb. 17, 2022

(54) LIQUID PESTICIDAL COMPOSITION

(71) Applicant: SUMITOMO CHEMICAL COMPANY, LIMITED, Tokyo (JP)

(72) Inventor: Takuya TANAKA, Takarazuka-shi (JP)

(73) Assignee: SUMITOMO CHEMICAL COMPANY, LIMITED, Tokyo (JP)

(21) Appl. No.: 17/109,400

(22) Filed: Dec. 2, 2020

(51) Int. Cl. A01N 43/54

(52) U.S. Cl. CPC A01N 43/54

(57) ABSTRACT

Provided is a liquid pesticidal composition comprising: (a) a compound represented by the following formula (I); (b) a solvent having a water solubility at 25° C. of 1 mass % or less; (c) an ionic surfactant; and (d) a nonionic surfactant.

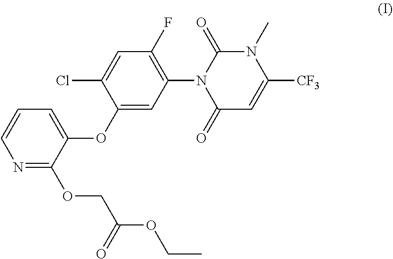 [SMILES: CCOC(=O)COc1ncccc1Oc1cc(-n2c(=O)cc(C(F)(F)F)n(C)c2=O)c(F)cc1Cl]

### BACKGROUND OF THE INVENTION

### Field of the Invention

The present invention relates to a liquid pesticidal composition.

### Description of the Background Art

U.S. Pat. No. 6,537,948 discloses a compound represented by the following formula (I).

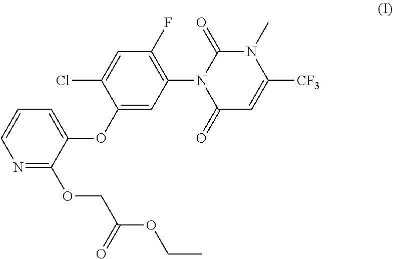 [SMILES: CCOC(=O)COc1ncccc1Oc1cc(-n2c(=O)cc(C(F)(F)F)n(C)c2=O)c(F)cc1Cl]

### SUMMARY OF THE INVENTION

An object of the present invention is to provide a liquid pesticidal composition comprising a compound represented by the above formula (I), wherein the liquid pesticidal composition has an excellent emulsion stability when mixed with water.

The present invention provides a liquid pesticidal composition described below.

[1] A liquid pesticidal composition comprising:

(a) a compound represented by the following formula (I);

(b) a solvent having a water solubility at 25° C. of 1 mass % or less;

(c) an ionic surfactant; and

(d) a nonionic surfactant.

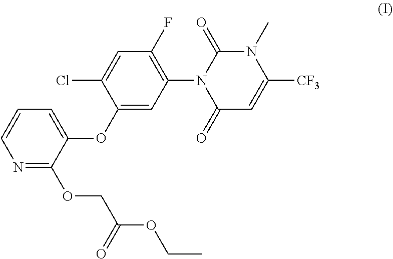 [SMILES: CCOC(=O)COc1ncccc1Oc1cc(-n2c(=O)cc(C(F)(F)F)n(C)c2=O)c(F)cc1Cl]

It is made possible to provide a liquid pesticidal composition comprising a compound represented by the above formula (I), wherein the liquid pesticidal composition has an excellent emulsion stability when mixed with water.

### DESCRIPTION OF THE PREFERRED EMBODIMENTS

A liquid pesticidal composition according to the present invention (hereinafter, also simply called “liquid pesticidal composition”) comprises:

(a) a compound represented by the following formula (I) (hereinafter, also called “compound X”);

(b) a solvent having a water solubility at 25° C. of 1 mass % or less;

(c) an ionic surfactant; and

(d) a nonionic surfactant.

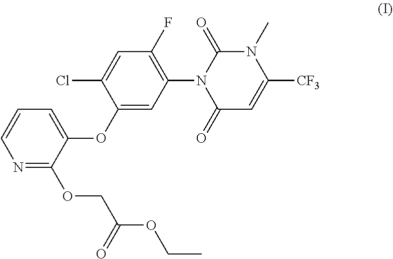 [SMILES: CCOC(=O)COc1ncccc1Oc1cc(-n2c(=O)cc(C(F)(F)F)n(C)c2=O)c(F)cc1Cl]

The term “liquid” herein refers to being fluid at 25° C. Preferably, the liquid pesticidal composition is a liquid in which at least the pesticidal active ingredient, among its ingredients, is completely or nearly completely dissolved in the solvent. More preferably, the liquid pesticidal composition is a liquid in which at least the pesticidal active ingredient and the surfactant, among its ingredients, are completely or nearly completely dissolved in the solvent. Further preferably, the liquid pesticidal composition is a liquid in which all of its ingredients are completely or nearly completely dissolved in the solvent.

The liquid pesticidal composition can be suitably used as a liquid pesticidal formulation called an emulsifiable concentrate (EC) in the agrochemical field.

In the following, a detailed description will be given of ingredients that the liquid pesticidal composition according to the present invention contains or may contain.

(a) Compound X

The liquid pesticidal composition contains a compound X as a pesticidal active ingredient. The compound X is a known compound and represented by the formula (I) below. The compound X may be produced by a known method such as a method described in U.S. Pat. No. 6,537,948.

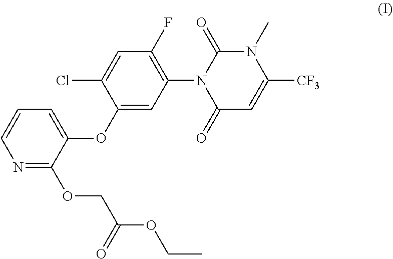 [SMILES: CCOC(=O)COc1ncccc1Oc1cc(-n2c(=O)cc(C(F)(F)F)n(C)c2=O)c(F)cc1Cl]

With the total amount of the liquid pesticidal composition being taken as 100 mass %, the content of the compound X in the liquid pesticidal composition is typically from 2 mass % to 30 mass %, preferably from 3 mass % to 10 mass %, more preferably from 3.5 mass % to 10 mass %, further preferably from 4 mass % to 10 mass %, yet further preferably from 4 mass % to 8 mass %. Other preferable ranges of this content are, for example, from 3 mass % to 8 mass %, from 3 mass % to 6 mass %, from 3.5 mass % to 8 mass %, from 5 mass % to 10 mass %, and from 5 mass % to 8 mass %.

(b) Solvent

The liquid pesticidal composition contains one, two, or more solvents having a water solubility at 25° C. of 1 mass % or less (hereinafter, also called “water-immiscible solvent”).

Examples of the water-immiscible solvent include:

alcohols such as hexanol, heptanol, and octanol;

esters such as methyl caproate, methyl caprylate, methyl caprate, methyl laurate, methyl myristate, methyl palmitate, methyl stearate, methyl oleate, methyl linoleate, ethyl acetate, butyl acetate, hexyl acetate, octyl acetate, benzyl acetate, methyl benzoate, ethyl benzoate, butyl benzoate, dimethyl phthalate, diethyl phthalate, diethyl oxalate, dioctyl succinate, methyl salicylate, dimethyl 2-methylglutarate, dimethyl 2-ethylsuccinate, dimethyl adipate, dibutyl adipate, didecyl adipate, tert-butyl acetoacetate, allyl acetoacetate, and 2-ethylhexyl lactate;

ethers such as propylene glycol phenyl ether;

ketones such as acetophenone;

amides such as N,N-dimethyloctanamide, N,N-dimethyldecanamide, N,N-dimethyldodecanamide, N,N-dimethyltetradecanamide, N,N-dimethyloctadecanamide, and N,N-dimethyl-9-deceneamide;

lactams such as N-octyl-pyrrolidone, N-decyl-pyrrolidone, and N-dodecyl-pyrrolidone;

aliphatic hydrocarbons such as hexane, octane, decane, tridecane, tetradecane, hexadecane, octadecane, normal paraffin, isoparaffin, cycloparaffin, 1-undecene, and 1-heneicosene;

aromatic hydrocarbons, for example, alkyl benzenes such as toluene, xylene, ethylbenzene, octadecylbenzene, dialkylbenzene, and trialkylbenzene, alkyl naphthalenes such as methylnaphthalene, dimethylnaphthalene, dodecylnaphthalene, and tridecylnaphthalene, and phenylxylylethane and 1-phenyl-1-ethylphenylethane, and a mixture of these;

fatty acids such as caproic acid, caprylic acid, capric acid, oleic acid, linoleic acid, and enanthic acid;

animal- or vegetable-derived oils such as olive oil, soybean oil, rape oil, castor oil, linseed oil, cottonseed oil, palm oil, avocado oil, coconuts oil, and shark liver oil; and

mineral oils such as machine oil.

As the water-immiscible solvent, a commercially available solvent may be used. Examples of a commercially available product for use as the water-immiscible solvent, in trade names, are described in Table 2-1.

For ensuring that the liquid pesticidal composition has a favorable emulsion stability when mixed with water, it is preferable that the water-immiscible solvent comprise an aromatic hydrocarbon. Preferably, the aromatic hydrocarbon comprises one or more selected from the group consisting of alkyl benzenes and alkyl naphthalenes, more preferably one or more selected from the group consisting of C9-C12 alkyl benzenes and C10-C15 alkyl naphthalenes, further preferably one or more selected from the group consisting of C9-C10 dialkyl- and trialkylbenzene, C10-C11 alkyl benzene, and C10-C13 alkyl naphthalene. The water-immiscible solvent may consist of an aromatic hydrocarbon.

The water solubility of the water-immiscible solvent at 25° C. is 1 mass % or less, and, for example, it may be 0.9 mass % or less, even 0.8 mass % or less. The water solubility of the water-immiscible solvent at 25° C. is usually 0 mass % or more, and it may be 10⁻⁵ mass % or more. It is preferable for the liquid pesticidal composition to contain a water-immiscible solvent having a water solubility within this range, because such a liquid pesticidal composition when used as an emulsifiable concentrate can readily form an emulsion when mixed with water.

Herein, the water solubility at 25° C. refers to the solubility in water at a temperature of 25° C. and pH7. For example, a water solubility at 25° C. of 1 mass % means that the solubility in 1 g of water at a temperature of 25° C. and pH7 is 1×10⁻² g.

As the water solubility of the water-immiscible solvent, a value found in the database (Solubility Database) of International Union of Pure and Applied Chemistry (IUPAC) or National Institute of Standards and Technology (NIST) may be used. When a corresponding value is not found in the database, the water solubility of the water-immiscible solvent may be measured by determining the saturation solubility in water at a temperature of 25° C. and pH7 by high-performance liquid chromatography.

With the total amount of the liquid pesticidal composition being taken as 100 mass %, the content of the water-immiscible solvent in the liquid pesticidal composition is preferably from 10 mass % to 90 mass %, more preferably from 20 mass % to 88 mass %, further preferably from 25 mass % to 85 mass %.

The content of the water-immiscible solvent relative to the content of the compound X is usually from 5 times by mass to 50 times by mass, preferably from 6 times by mass to 40 times by mass, more preferably from 7 times by mass to 30 times by mass, further preferably from 8 times by mass to 25 times by mass, yet further preferably from 9 times by mass to 20 times by mass, particularly preferably from 10 times by mass to 15 times by mass. Other preferable ranges of the ratio (mass ratio) of the content of the water-immiscible solvent to the content of the compound X are from 6 times by mass to 25 times by mass, from 6 times by mass to 20 times by mass, from 6 times by mass to 15 times by mass, from 8 times by mass to 20 times by mass, from 8 times by mass to 15 times by mass, from 10 times by mass to 25 times by mass, from 10 times by mass to 20 times by mass, and from 10 times by mass to 15 times by mass.

When the liquid pesticidal composition contains two or more water-immiscible solvents, the above-described content of the water-immiscible solvent is a total content of these two or more water-immiscible solvents. The same is true for other ingredients that the liquid pesticidal composition contains or may contain; when a given ingredient comprises two or more types of the same ingredient, the content of that given ingredient is a total content of these two or more types, unless otherwise specified.

(c) Ionic Surfactant

The liquid pesticidal composition contains one, two, or more ionic surfactants. Examples of the ionic surfactant include an anionic surfactant, a cationic surfactant, and an amphoteric surfactant.

Examples of the anionic surfactant include:

alkylsulfonic acid salts such as dodecyl sulfonic acid salts;

alpha-olefin sulfonic acid salts such as tetradecene sulfonic acid salts;

alkyl aryl sulfonic acid salts such as alkylbenzenesulfonic acid salts and alkyl naphthalene sulfonic acid salts;

dialkyl sulfosuccinic acid salts such as di(2-ethylhexyl) sulfosuccinic acid salts;

N-acyl-N-methyltaurine salts such as oleoylmethyltaurine salts;

alkyl sulfuric acid ester salts such as lauryl sulfuric acid salts;

polyoxyethylene alkyl ether sulfuric acid ester salts such as laureth sulfuric acid salts;

polyoxyethylene aryl ether sulfuric acid ester salts such as polyoxyethylene distyrylphenyl ether sulfuric acid ester salts;

alkyl phosphoric acid ester salts such as lauryl phosphoric acid salts;

polyoxyethylene alkyl ether phosphoric acid ester salts;

fatty acid salts such as octanoic acid salts, decanoic acid salts, lauric acid salts, palmitic acid salts, stearic acid salts;

N-acyl sarcosine salts such as oleoylsarcosine salts and stearoyl/myristoyl sarcosine salts; and

N-acyl glutamic acid salts such as lauroyl glutamic acid salts and cocoyl glutamic acid salts.

Each of the above sulfonic acid salts, the above sulfosuccinic acid salts, the above taurine salts, the above sulfuric acid ester salts, the above phosphoric acid ester salts, the above fatty acid salts, the above sarcosine salts, and the above glutamic acid salts may be a sodium salt, a potassium salt, a calcium salt, an ammonium salt, an isopropylamine salt, a triethanolamine salt, and the like.

Examples of the cationic surfactant include:

alkylamine hydrochloric acid salts such as dodecylamine hydrochloric acid salts; and

alkyl quaternary ammonium salts such as dodecyltrimethylammonium salts, alkyl dimethylbenzylammonium salts, alkyl pyridinium salts, alkyl isoquinolinium salts, and dialkyl morpholinium salts;

Examples of the amphoteric surfactant include N-laurylalanine, N,N,N-trimethylaminopropionic acid, N,N,N-trihydroxyethylaminopropionic acid, N-hexyl-N,N-dimethylaminoacetic acid, 1-(2-carboxyethyl) pyrimidinium betaine, and lecithin.

As the ionic surfactant, a commercially available ionic surfactant may be used.

Examples of a commercially available anionic surfactant and cationic surfactant, in trade names, are described in Table 2-1.

(d) Nonionic Surfactant

The liquid pesticidal composition contains one, two, or more nonionic surfactants. Examples of the nonionic surfactant include:

polyoxyalkylene block copolymers such as polyoxyethylene polyoxypropylene block copolymers;

polyoxyalkylene fatty acid esters such as polyoxyethylene fatty acid esters and polyoxyethylene polyoxypropylene fatty acid esters;

polyoxyalkylene alkyl ethers such as polyoxyethylene alkyl ethers and polyoxyethylene polyoxypropylene alkyl ethers;

polyoxyalkylene polyaryl ethers such as polyoxyethylene tristyrylphenyl ether, polyoxyethylene polyaryl ether, and polyoxyethylene polyoxypropylene polyaryl ether;

polyoxyalkylene alkyl aryl ethers such as polyoxyethylene alkyl aryl ethers and polyoxyethylene polyoxypropylene alkyl aryl ethers;

polyoxyalkylene vegetable oils such as polyoxyethylene castor oil and polyoxyethylene polyoxypropylene castor oil;

polyoxyalkylene hydrogenated vegetable oils such as polyoxyethylene hydrogenated castor oil;

glycerol fatty acid esters;

sorbitan fatty acid esters such as sorbitan laurate, sorbitan stearate, sorbitan oleate, and sorbitan trioleate;

polyoxyalkylene sorbitan fatty acid esters such as polyoxyethylene sorbitan laurate, polyoxyethylene sorbitan stearate, polyoxyethylene sorbitan oleate, and polyoxyethylene sorbitan trioleate; and

alkoxylated amines such as alkoxylate ethylenediamines.

As the nonionic surfactant, a commercially available nonionic surfactant may be used.

Examples of a commercially available nonionic surfactant, in trade names, are described in Table 2-2, Table 2-3 and Table 2-4.

In the liquid pesticidal composition, the content ratio between one or more nonionic surfactants and one or more ionic surfactants is 1:0.1 to 1:40 (mass ratio), for example.

With the total amount of the liquid pesticidal composition being taken as 100 mass %, the total content of the ionic surfactant and the nonionic surfactant in the liquid pesticidal composition is preferably from 1 mass % to 30 mass %, more preferably from 3 mass % to 28 mass %, further preferably from 6 mass % to 26 mass %, yet further preferably from 9 mass % to 24 mass %, particularly preferably from 12 mass % to 24 mass %.

With the total amount of the liquid pesticidal composition being taken as 100 mass %, the total content of the compound X, the water-immiscible solvent, the ionic surfactant, and the nonionic surfactant in the liquid pesticidal composition is preferably 60 mass % or more, more preferably 70 mass % or more, further preferably 75 mass % or more. That total content may be 100 mass %, may be 95 mass % or less, may be 90 mass % or less, or may be 85 mass % or less.

(e) Other Ingredients

The liquid pesticidal composition may contain ingredients other than those described above, as needed.

Examples of such other ingredients include a pesticidal active ingredient other than the compound X, a solvent other than the water-immiscible solvent, and a formulation auxiliary ingredients.

With the total amount of the pesticidal active ingredient contained in the liquid pesticidal composition being taken as 100 mass %, the content of the compound X relative to the total content of all the pesticidal active ingredients contained in the liquid pesticidal composition may be, for example, from 20 mass % to 100 mass % or from 30 mass % to 100 mass %. For example, this content is from 50 mass % to 100 mass %, from 60 mass % to 100 mass %, from 80 mass % to 100 mass %, from 90 mass % to 100 mass %, or from 95 mass % to 100 mass %.

The pesticidal active ingredient other than the compound X is not particularly limited, and examples thereof include an insecticidal active ingredient, a fungicidal active ingredient, a herbicidal active ingredient, a plant-growth-regulating agent active ingredient, and a safener. The liquid pesticidal composition may contain one or more pesticidal active ingredients selected from the group consisting of an insecticidal active ingredient, a fungicidal active ingredient, a herbicidal active ingredient, a plant-growth-regulating agent active ingredient, and a safener, as the pesticidal active ingredient other than the compound X.

Each of the insecticidal active ingredient, the fungicidal active ingredient, the herbicidal active ingredient, the plant-growth-regulating agent active ingredient, and the safener may comprise one, two, or more types of the same ingredient.

Examples of the herbicidal active ingredient that may be further contained in the liquid pesticidal composition in addition to the compound X include those described below.

Herbicidal active ingredients: 2,3,6-TBA (2,3,6-trichlorobenzoic acid), 2,3,6-TBA-dimethylammonium, 2,3,6-TBA-lithium, 2,3,6-TBA-potassium, 2,3,6-TBA-sodium, 2,4-D, 2,4-D choline salt, 2,4-D-biproamine, 2,4-D-doboxyl, 2,4-D-2-ethylhexyl, 2,4-D-3-butoxypropyl, 2,4-D-ammonium, 2,4-D-butotyl, 2,4-D-butyl, 2,4-D-diethylammonium, 2,4-D-dimethylammonium, 2,4-D-diolamine, 2,4-D-dodecylammonium, 2,4-D-ethyl, 2,4-D-heptylammonium, 2,4-D-isobutyl, 2,4-D-isooctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 2,4-DB, 2,4-DB choline salt, 2,4-DB-biproamine, 2,4-DB-butyl, 2,4-DB-dimethylammonium, 2,4-DB-isoctyl, 2,4-DB-potassium, 2,4-DB-sodium, acetochlor, acifluorfen, acifluorfen-sodium, aclonifen, ACN (2-amino-3-chloronaphthalene-1,4-dione), alachlor, allidochlor, alloxydim, ametryn, amicarbazone, amidosulfuron, aminocyclopyrachlor, aminocyclopyrachlor-methyl, aminocyclopyrachlor-potassium, aminopyralid, aminopyralid choline salt, aminopyralid-potassium, aminopyralid-tripromine, amiprophos-methyl, amitrole, anilofos, asulam, atrazine, azafenidin, azimsulfuron, beflubutamid, benazolin-ethyl, bencarbazone, benfluralin, benfuresate, bensulfuron, bensulfuron-methyl, bensulide, bentazon, benthiocarb, benzfendizone, benzobicyclon, benzofenap, benzthiazuron, bialafosbialaphos, bicyclopyrone, bifenox, bispyribac, bispyribac-sodium, bixlozone, bromacil, bromobutide, bromofenoxim, bromoxynil, bromoxynil-octanoate, butachlor, butafenacil, butamifos, butralin, butroxydim, butylate, cafenstrole, carbetamide, carfentrazone, carfentrazone-ethyl, chlomethoxyfen, chloramben, chloridazon, chlorimuron, chlorimuron-ethyl, chlorobromuron, chlorotoluron, chloroxuron, chlorpropham, chlorsulfuron, chlorthal-dimethyl, chlorthiamid, cinidon, cinidon-ethyl, cinmethylin, cinosulfuron, clethodim, clodinafop, clodinafop-propargyl, clomazone, clomeprop, clopyralid, clopyralid choline salt, clopyralid-methyl, clopyralid-olamine, clopyralid-potassium, clopyralid-tris(2-hydroxypropyl)ammonium, cloransulam, cloransulam-methyl, cumyluron, cyanazine, cyclopyranil, cycloate, cyclopyrimorate, cyclosulfamuron, cycloxydim, cyhalofop, cyhalofop-butyl, daimuron, dalapon, dazomet, desmedipham, desmetryn, di-allate, dicamba, dicamba choline salt, dicamba-biproamine, dicamba-trolamine, dicamba-diglycolamine, dicamba-dimethylammonium, dicamba-diolamine, dicamba-isopropylammonium, dicamba-methyl, dicamba-olamine, dicamba-potassium, dicamba-sodium, dichlobenil, dichlorprop, dichlorprop choline salt, dichlorprop-biproamine, dichlorprop-etexyl, dichlorprop-butotyl, dichlorprop-dimethylammonium, dichlorprop-ethylammonium, dichlorprop-isoctyl, dichlorprop-methyl, dichlorprop-P, dichlorprop-P choline salt, dichlorprop-P-biproamine, dichlorprop-P-etexyl, dichlorprop-P-dimethylammonium, dichlorprop-potassium, dichlorprop-sodium, diclofop, diclofop-methyl, diclosulam, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimepiperate, dinitramine, dinoseb, dinoterb, diphenamid, diquat, diquat-dibromide, DSMA (disodium methylarsonate), dithiopyr, diuron, DNOC (2-methyl-4,6-dinitrophenol), esprocarb, ethalfluralin, ethametsulfuron, ethametsulfuron-methyl, ethidimuron, ethofumesate, ethoxyfen-ethyl, ethoxysulfuron, etobenzanid, fenoxaprop, fenoxaprop-ethyl, fenoxaprop-P, fenoxaprop-P-ethyl, fenoxasulfone, fenquinotrione, fentrazamide, fenuron, flamprop-M, flazasulfuron, florasulam, florpyrauxifen, florpyrauxifen-benzyl, fluazifop, fluazifop-butyl, fluazifop-P, fluazifop-P-butyl, fluazolate, flucarbazone, flucarbazone-sodium, flucetosulfuron, flufenacet, flufenpyr, flufenpyr-ethyl, flumetsulam, flumetsulam, flumiclorac, flumiclorac-pentyl, flumioxazin, fluometuron, fluoroglycofen-ethyl, flupoxam, flupropanate, flupyrsulfuron, flupyrsulfuron-methyl-sodium, flurenol, fluridone, flurochloridone, fluroxypyr, fluroxypyr-butometyl, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P, glufosinate-P-ammonium, glufosinate-P-sodium, glyphosate, glyphosate choline salt, glyphosate-isopropylammonium, glyphosate-biproamine, glyphosate-ammonium, glyphosate-diammonium, glyphosate-potassium, glyphosate-sodium, glyphosate-trimesium, halauxifen, halauxifen-methyl, halosafen, halosulfuron, halosulfuron-methyl, haloxyfop, haloxyfop-etotyl, haloxyfop-methyl, haloxyfop-P, haloxyfop-P-etotyl, haloxyfop-P-methyl, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-ammonium, imazosulfuron, indanofan, indaziflam, iodosulfuron, iodosulfuron-methyl-sodium, iofensulfuron, iofensulfuron-sodium, ioxynil, ioxynil-octanoate, ipfencarbazone, isoproturon, isouron, isoxaben, isoxachlortole, isoxaflutole, lactofen, lenacil, linuron, maleic hydrazide, MCPA (2-(4-chloro-2-methylphenoxy)acetic acid), MCPA choline salt, MCPA-biproamine, MCPA-etexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-sodium, MCPA-trolamine, MCPB (4-(4-chloro-2-methylphenoxy)butanoic acid), MCPB choline salt, MCPB-biproamine, MCPB-ethyl, MCPB-methyl, MCPB-sodium, mecoprop, mecoprop choline salt, mecoprop-biproamine, mecoprop-2-ethylhexyl, mecoprop-dimethylammonium, mecoprop-diolamine, mecoprop-ethadyl, mecoprop-isoctyl, mecoprop-methyl, mecoprop-potassium, mecoprop-sodium, mecoprop-trolamine, mecoprop-P, mecoprop-P choline salt, mecoprop-P-2-ethylhexyl, mecoprop-P-dimethylammonium, mecoprop-P-isobutyl, mecoprop-P-potassium, mefenacet, mesosulfuron, mesosulfuron-methyl, mesotrione, metam, metamifop, metamitron, metazachlor, metazosulfuron, methabenzthiazuron, methiozolin, methyldymron, metobromuron, metolachlor, metosulam, metoxuron, metribuzin, metsulfuron, metsulfuron-methyl, molinate, monolinuron, naproanilide, napropamide, napropamide-M, naptalam, neburon, nicosulfuron, norflurazon, oleic acid, orbencarb, orthosulfamuron, oryzalin, oxadiargyl, oxadiazon, oxasulfuron, oxaziclomefone, oxyfluorfen, paraquat, paraquat-dichloride, pebulate, pelargonic acid, pendimethalin, penoxsulam, pentanochlor, pentoxazone, pethoxamid, phenisopham, phenmedipham, picloram, picolinafen, pinoxaden, piperophos, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen-ethyl, pyrasulfotole, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quizalofop, quizalofop-ethyl, quizalofop-tefuryl, quizalofop-P, quizalofop-P-ethyl, quizalofop-P-tefuryl, rimsulfuron, saflufenacil, sethoxydim, EPTC (S-ethyl N,N-dipropylcarbamothioate), siduron, simazine, simetryn, S-metolachlor, MSMA (sodium hydrogen methylarsonate), sulcotrione, sulfentrazone, sulfometuron, sulfometuron-methyl, sulfosulfuron, swep, TCA (2,2,2-trichloroacetic acid), TCA-ammonium, TCA-calcium, TCA-ethadyl, TCA-magnesium, TCA-sodium, tebutam, tebuthiuron, tefuryltrione, tembotrione, tepraloxydim, terbacil, terbumeton, terbuthylazine, terbutryn, tetflupyrolimet, thaxtomin A, thenylchlor, thiazopyr, thidiazimin, thiencarbazone, thiencarbazone-methyl, thifensulfuron, thifensulfuron-methyl, tiafenacil, tiocarbazil, tolpyralate, topramezone, tralkoxydim, triafamone, tri-allate, triasulfuron, triaziflam, tribenuron, tribenuron-methyl, triclopyr, triclopyr-butotyl, triclopyr-ethyl, triclopyr-triethylammonium, tridiphane, trietazine, trifloxysulfuron, trifloxysulfuron-sodium, trifludimoxazin, trifluralin, triflusulfuron, triflusulfuron-methyl, tritosulfuron, vernolate, 4-(4-fluorophenyl)-6-[(2-hydroxy-6-oxo-1-cyclohexen-1-yl)carbonyl]-2-methyl-1,2,4-triazine-3,5(2H,4H)-dione, 2-chloro-N-(1-methyl-1H-tetrazol-5-yl)-3-(methylthio)-4-(trifluoromethyl)benzamide, 2-methyl-N-(5-methyl-1,3,4-oxadiazol-2-yl)-3-(methanesulfonyl)-4-(trifluoromethyl)benzamide, 4-amino-3-chloro-5-fluoro-6-(7-fluoro-1H-indol-6-yl)pyridine-2-carboxylic acid, 4-amino-3-chloro-5-fluoro-6-(7-fluoro-1H-indol-6-yl)pyridine-2-carboxylic acid cyano methyl ester, (2R,4R)-4-({[(5S)-3-(3,5-difluorophenyl)-5-vinyl-4,5-dihydroisoxazol-5-yl]carbonyl}amino)tetrahydrofuran-2-carboxylic acid methyl ester, (2S,4S)-4-({[(5R)-3-(3,5-difluorophenyl)-5-vinyl-4,5-dihydroisoxazol-5-yl]carbonyl}amino)tetrahydrofuran-2-carboxylic acid methyl ester, 3-[(isopropylsulfonyl)methyl]-N-(5-methyl-1,3,4-oxadiazol-2-yl)-5-(trifluoromethyl)-1,2,4-triazo[4,3-a]pyridine-8-carboxamide, 1-{2-chloro-6-[(5-chloropyrimidin-2-yl)oxy]phenyl}-4,4,4-trifluorobutan-1-one, and 5-chloro-2-{3-chloro-2-[5-(difluoromethyl)isoxazol-3-yl]phenoxy}pyrimidine.

In the present invention, as a herbicidal active ingredient that may be further contained in the liquid pesticidal composition, glyphosate-potassium salt, glyphosate-dimethylamine salt, glyphosate-monoethanolamine salt, glufosinate-ammonium salt, glufosinate-P-ammonium salt, glyphosate-isopropylammonium salt, 2,4-D-choline salt, dicamba-diglycolamine salt, dicamba-N,N-bis(3-aminopropyl)methylamine salt, dicamba-tetrabutylamine salt, dicamba-tetrabutyiphosphonium salt, pyroxasulfone, flumioxazin, flumiclorac-pentyl, clethodim, lactofen, S-metolachlor, metribuzin, flufenacet, nicosulfuron, rimsulfuron, acetochlor, mesotrione, isoxaflutole, chlorimuron-ethyl, thifensulfuron-methyl, cloransulam-methyl, and imazethapyr-ammonium salt are particularly preferable.

For ensuring that the liquid pesticidal composition has a favorable emulsion stability when mixed with water, with the total content of solvents contained in the liquid pesticidal composition being taken as 100 mass %, the total content of the water-immiscible solvent relative to the total content of all the solvents contained in the liquid pesticidal composition is preferably 70 mass % or more, more preferably 80 mass % or more, further preferably 90 mass % or more, yet further preferably 95 mass % or more, especially preferably 98 mass % or more, particularly preferably 100 mass %.

Examples of the formulation auxiliary ingredients include an antifoaming agent. The antifoaming agent may be an antifoaming agent soluble in an organic solvent or dispersible in an organic solvent. When the liquid pesticidal composition contains an antifoaming agent, the content is usually from 0.001 mass % to 1 mass %, preferably from 0.002 mass % to 0.8 mass %, with the total amount of the liquid pesticidal composition being taken as 100 mass %.

(f) Production and Use of Liquid Pesticidal Composition

The liquid pesticidal composition can be suitably used as a liquid pesticidal formulation called an emulsifiable concentrate in the agrochemical field.

The liquid pesticidal composition may be produced by a typical method of producing an emulsifiable concentrate, and, for example, it may be produced by mixing, on heating as needed, the compound X, the water-immiscible solvent, the ionic surfactant, and the nonionic surfactant, and an optional ingredient. The liquid pesticidal composition may be filtered with a mesh, followed by packaging it into commercial bottles or containers.

The liquid pesticidal composition is applied according to a method that is usually employed for an emulsifiable concentrate, to control pests and/or weeds. More specifically, the liquid pesticidal composition is mixed with water to prepare an emulsion, and the resulting emulsion is applied to a plant or a soil in which a plant is grown.

The emulsion is prepared by mixing with water in a volume usually 2 to 10000 times, preferably 10 to 8000 times, more preferably 15 to 6000 times the volume of the liquid pesticidal composition.

For application of the emulsion, the liquid pesticidal composition may be tank-mixed with an adjuvant. The type of the adjuvant is not particularly limited, and desirably, an oil-based adjuvant (a mineral oil such as a paraffin-based hydrocarbon, a naphthene-based hydrocarbon, or an aromatic hydrocarbon, or Methylated Seed Oil which is an esterified vegetable oil (soybean oil and/or rape oil)) such as AGRI-DEX® (mixture of heavy range paraffinic oil, polyol fatty acid esters, and polyethoxylated derivatives thereof, manufactured by Helena Chemical Company) or MSO is mixed in a spray liquid at 0.25%, 0.5%, 1%, 2%, 3%, 4%, 5%, or 6% (volume/volume), while a nonionic surfactant-based adjuvant (a polyoxyalkylene alkyl ether, a polyoxyalkylene fatty acid ester, an alkyl aryl alkoxylate, or an alkyl aryl polyoxyalkylene glycol) such as INDUCE® (mixture of alkyl aryl polyoxylkane ethers, alkanolamides, dimethyl siloxane, and free fatty acids, manufactured by Helena Chemical Company) is mixed in a spray liquid at 0.05%, 0.1%, 0.25%, or 0.5% (volume/volume). Additional examples include anionic surfactant-based adjuvants (substituted sulfonate) such as Gramin S, cationic surfactant-based adjuvants (polyoxyethylene amine) such as Genamin T 200BM, and organic silicone surfactant-based adjuvants such as Silwet® L77 (siloxane polyalkyleneoxide copolymer, manufactured by Helena Chemical Company). A drift-reducing agent such as INTACT™ (mixture of polyethylene glycol, choline chloride, and guar gum, manufactured by Precision Laboratories) and/or a volatility-reducing agent such as VAPEX™, A VAPORGRIP® XTRA AGENT (mixture of potassium hydrate, and ethanoic acid, manufactured by KALO, Inc) may also be mixed. The pH and the hardness of the spray liquid are not particularly limited.

In addition, for application of the emulsion, the liquid pesticidal composition may be tank-mixed with a formulated product which contain one or more pesticidal active ingredients selected from the group consisting of an insecticidal active ingredient, a fungicidal active ingredient, a herbicidal active ingredient, a plant-growth regulating agent active ingredient, and a safener, as the pesticidal active ingredient other than the compound X. Examples of the herbicidal active ingredient that may be tank-mixed with the liquid pesticidal composition include aforementioned those. The type of the formulation of the formulated product that may be tank-mixed with the liquid herbicidal composition may be liquid or solid. As the formulated product that may be tank-mixed with the liquid pesticidal composition, a commercially available pesticidal composition may be used. Examples of a commercially available pesticidal composition, in trade names, are described as follows: ROUNDUP WEATHERMAX® HERBICIDE (glyphosate potassium salt 660 g/L as acid equivalent, manufactured by Bayer), XTENDIMAX® WITH VAPORGRIP® TECHNOLOGY (dicamba diglycolamine salt, 350 g/L as acid equivalent, manufactured by Bayer), ROUNDUP XTEND® WITH VAPORGRIP® TECHNOLOGY (glyphosate monoethanolamine salt 240 g/L as acid equivalent+dicamba diglycolamine salt, 120 g/L as acid equivalent, manufactured by Bayer), VALOR® SX HERBICIDE (flumioxazin 51 w/w %, manufactured by Valent U.S.A. LLC), FIERCE® HERBICIDE (flumioxazin 33.5 w/w %+pyroxasulfone 42.5 w/w %, manufactured by Valent U.S.A. LLC).

The order of the addition of the liquid pesticidal composition, the formulated product that may be tank-mixed with the liquid herbicidal composition if needed, the adjuvant if needed, and water to prepare the emulsion in tank is not particularly limited.

The crop field in the present invention may include a food crop field such as a peanut field, a soybean (indeterminate growth habit, determinate growth habit, semi-determinate growth habit) field, a corn (dent corn, flint corn, flour corn, popcorn, waxy corn, sweet corn) field and a wheat (bread wheat (soft wheat, hard wheat, medium wheat, red wheat, white wheat), durum wheat, spelt wheat, club wheat, and, winter habit and spring habit thereof) field, a barley (two-row barley, six-row barley, hulless barley, hulless waxy barley and, winter habit and spring habit thereof) field, a feed crop field such as a Sorghum field and an oat field, an industrial crop field such as a cotton (upland cotton, pima cotton) field and a rapeseed field, a canola (winter habit, spring habit) field and sugar crops such as a sugarcane field and a sugar beet field.

The vegetable field in the present invention may include a field for cultivating solanaceae vegetables (eggplant, tomato, green pepper, chili pepper, potato, etc.), a field for cultivating cucurbitaceae vegetables (cucumber, pumpkin, zucchini, watermelon, melon, etc.), a field for cultivating cruciferous vegetables (radish, turnip, horseradish, kohlrabi, Chinese cabbage, cabbage, mustard, broccoli, cauliflower, etc.), a field for cultivating asteraceae vegetables (burdock, crown daisy, artichoke, lettuce, etc.), a field for cultivating liliaceae vegetables (welsh onion, onion, garlic, asparagus, etc.), a field for cultivating umbelliferae vegetables (carrot, parsley, celery, parsnip, etc.), a field for cultivating chenopodiaceae vegetables (spinach, beet, etc.), a field for cultivating lamiaceae vegetables (perilla, mint, basil, lavender, etc.), a strawberry field, a sweet potato field, a yam field, and an aroid field, etc.

The land under perennial crops in the present invention may include an orchard, a tea field, a mulberry field, a coffee field, a banana field, a palm field, a flowering tree farm, a flowering tree field, a planting stock field, a nursery field, a forest land, or a garden. The orchard tree in the present invention may include pomaceous fruits (apple, pear, Japanese pear, Chinese quince, quince, etc.), stone fruits (peach, plum, nectarine, Japanese apricot, yellow peach, apricot, prune, etc.), citrus fruits (citrus unshiu, orange, lemon, lime, grapefruit, etc.), nut trees (chestnut, walnut, hazelnut, almond, pistachio, cashew nut, macadamia nut, etc.), berry fruits (grape, blueberry, cranberry, blackberry, raspberry, etc.), persimmon, olive, loquat, etc.

The non-crop area in the present invention may include an athletic field, an empty lot, a railroad edge, a park, a parking area, a road edge, a dry riverbed, under power lines, a building land, a factory site, etc.

The crops cultivated in a crop field in the present invention is not limited as long as their varieties are varieties which are usually cultivated as crops.

Examples of the weeds which can be controlled by the liquid pesticidal composition include the following weeds, but are not limited thereto.

Urticaceae weeds: small nettle (Urtica urens)

Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), common sorrel (Rumex acetosa)
Portulacaceae weeds: common purslane (Portulaca oleracea)
Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), five-wound catchfly (Silene gallica)
Molluginaceae weeds: carpetweed (Mollugo verticillata)
Chenopodiaceae weeds: common lambsquarters (Chenopodium album), Indian goosefoot (Chenopodium ambrosioides), Kochia (Kochia scoparia), spiny saltwort (Salsola kali), Orach (Atriplex spp.)
Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), perrotleaf (Alternanthera tenella)
Papaveraceae weeds: common poppy (Papaver rhoeas), field poppy (Papaver dubium), Mexican prickle poppy (Argemone mexicana)
Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), slender wartcress (Coronopus didymus)
Capparaceae weeds: African cabbage (Cleome affinis)
Fabaceae weeds: Indian joint vetch (Aeschynomene indica), zigzag joint vetch (Aeschynomene rudis), hemp Sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, common cowpea (Vigna sinensis)
Oxalidaceae weeds: creeping wood sorrel (Oxalis corniculata), European wood sorrel (Oxalis stricta), purple shamrock (Oxalis oxyptera)
Geraniaceae weeds: Carolina Geranium (Geranium carolinense), common storksbill (Erodium cicutarium)
Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic Croton (Croton glandulosus), lobed Croton (Croton lobatus), long-stalked Phyllanthus (Phyllanthus corcovadensis), castor bean (Ricinus communis)
Malvaceae weeds: velvetleaf (Abutilon theophrasti), arrow-leaf Sida (Sida rhombifolia), heart-leaf Sida (Sida cordifolia), prickly Sida (Sida spinosa), Sida glaziovii, Sida santaremnensis, bladder weed (Hibiscus trionum), spurred Anoda (Anoda cristata), spine-seeded false-mallow (Malvastrum coromandelianum)
Onagraceae weeds: Ludwigia epilobioides, long-fruited primrose willow (Ludwigia octovalvis), winged water primrose (Ludwigia decurrens), common evening-primrose (Oenothera biennis), cutleaf evening-primrose (Oenothera laciniata)
Sterculiaceae weeds: Florida Waltheria (Waltheria indica)
Violaceae weeds: field Violet; Viola arvensis, wild Violet; Viola tricolor
Cucurbitaceae weeds: bur cucumber (Sicyos angulatus), wild cucumber (Echinocystis lobata), bitter balsam apple (Momordica charantia)
Lythraceae weeds: Ammannia multiflora, eared redstem (Ammannia auriculata), scarlet toothcup (Ammannia coccinea), purple loosestrife (Lythrum salicaria), Indian toothcup (Rotala indica)
Elatinaceae weeds: three-stamen waterwort (Elatine triandra), California waterwort (Elatine californica)

Apiaceae weeds: Chinese celery (Oenanthe javanica), wild carrot (Daucus carota), carrot fern (Conium maculatum)

Araliaceae weeds: lawn pennywort (Hydrocotyle sibthorpioides), floating pennywort (Hydrocotyle ranunculoides)
Ceratophyllaceae weeds: common hornwort (Ceratophyllum demersum)
Cabombaceae weeds: Carolina fanwort (Cabomba caroliniana)
Haloragaceae weeds: Brazilian water milfoil (Myriophyllum aquaticum), whorled water milfoil (Myriophyllum verticillatum), water milfoils (Myriophyllum spicatum, Myriophyllum heterophyllum, etc.)
Sapindaceae weeds: heartseed (Cardiospermum halicacabum)
Primulaceae weeds: scarlet pimpernel (Anagallis arvensis)
Asclepiadaceae weeds: common milkweed (Asclepias syriaca), honeyvine milkweed (Ampelamus albidus)
Rubiaceae weeds: catchweed bedstraw (Galium aparine), Galium spurium var. echinospeiinon, broadleaf buttonweed (Spermacoce latifolia), Brazil calla lily
(Richardia brasiliensis), broadleaf buttonweed (Borreria alata)
Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), small-flower morning glory (Jacquemontia tamnifolia)
Boraginaceae weeds: field forget-me-not (Myosotis arvensis)
Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), field-nettle betony (Stachys arvensis)
Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), apple of Peru (Nicandra physalodes)
Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), Dopatrium (Dopatrium junceum), Gratiola japonica,
Plantaginaceae weeds: Asiatic plantain (Plantago asiatica), narrow-leaved plantain (Plantago lanceolata), broadleaf plantain (Plantago major), marsh water starwort (Callitriche palustris)
Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy Galinsoga (Galinsoga ciliata), small-flower Galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis), marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic Ageratum (Ageratum conyzoides), common bonelet (Eupatorium perfoliatum), fireweed (Erechtites hieracifolia), American cudweed (Gamochaeta spicata), linear-leaf cudweed (Gnaphalium spicatum), Jaegeria hirta, ragweed Parthenium (Parthenium hysterophorus), small yellow crownbeard (Siegesbeckia orientalis), lawn burweed (Soliva sessilis), white Eclipta (Eclipta prostrata), American false daisy (Eclipta alba), spreading sneezeweed (Centipeda minima)
Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channeled water plantain (Alisma canaliculatum), common water plantain (Alisma plantago-aquatica)
Limnocharitaceae weeds: Sawah flowering rush (Limnocharis flava)
Hydrocharitaceae weeds: American frogbit (Limnobium spongia), Florida elodea (Hydrilla verticillata), common water nymph (Najas guadalupensis)
Araceae weeds: Nile cabbage (Pistia stratiotes)
Lemnaceae weeds: three-nerved duckweed (Lemna aoukikusa, Lemna paucicostata, Lemna aequinoctialis), common duckmeat (Spirodela polyrhiza), Wolffia spp.
Potamogetonaceae weeds: roundleaf pondweed (Potamogeton distinctus), pondweeds (Potamogeton crispus, Potamogeton illinoensis, Stuckenia pectinata, etc.)
Liliaceae weeds: wild onion (Allium canadense), wild garlic (Allium vineale), Chinese garlic (Allium macrostemon)
Pontederiaceae weeds: common water hyacinth (Eichhornia crassipes), blue mud plantain (Heteranthera limosa), Monochoria korsakowii, heartshape false pickerelweed (Monochoria vaginalis)
Commelinaceae weeds: common dayflower (Commelina communis), tropical spiderwort (Commelina benghalensis), erect dayflower (Commelina erecta), Asian spiderwort (Murdannia keisak)
Poaceae weeds: common barnyardgrass (Echinochloa crus-galli), early barnyardgrass (Echinochloa oryzicola), barnyard grass (Echinochloa crus-galli var formosensis), late watergrass (Echinochloa oryzoides), jungle rice (Echinochloa colonum), Gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (grain Sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus tectorum), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall Panicum (Panicum dichotomiflorum), Texas Panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery Pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies Pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), Japanese lawngrass (Zoysia japonica)
Cyperaceae weeds: Asian flatsedge (Cyperus microiria), rice flatsedge (Cyperus iria), hedgehog Cyperus (Cyperus compressus), small-flowered nutsedge (Cyperus difformis), lax-flat sedge (Cyperus flaccidus), Cyperus globosus, Cyperus nipponicus, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green Kyllinga (Kyllinga brevifolia), grasslike Fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, river bulrush (Bolboschoenus fluviatilis)
Equisetaceae weeds: field horsetail (Equisetum arvense), marsh horsetail (Equisetum palustre)
Salviniaceae weeds: floating fern (Salvinia natans)
Azollaceae weeds: Japanese mosquitofern (Azolla japonica), feathered mosquito fern (Azolla pinnata)
Marsileaceae weeds: clover fern (Marsilea quadrifolia)
Other: Filamentous algae (Pithophora, Cladophora), Bryophyta, Marchantiophyta, Anthocerotophyta, Cyanobacteria, Pteridophyta, sucker of perennial crop (pome fruits, stone fruits, berry fruits, nuts, citrus fruits, hops, grapes, etc.)

Volunteer crops are crops that is shed or dropped by crops cultivated before the previous year. In particular, volunteer corn in a soybean field is one of the weeds to be controlled by the in the liquid pesticical composition of the present invention.

### EXAMPLES

Next, the present invention will be described in further detail with reference to Examples. The scope of the present invention is not limited to these Examples.

### Production Examples 1 to 500: Preparation and Evaluation of Liquid Pesticidal Composition

(1) Preparation of Liquid Pesticidal Composition

The ingredients specified in Table 1-1 to Table 1-25 are mixed in the mass ratios (%) specified in Table 1-1 to Table 1-25 and stirred to uniform dissolution, and thus liquid pesticidal compositions are obtained. Compound X Technical Grade (TG, 98% purity) is used as the source of the Compound X.

(2) Evaluation of Liquid Pesticidal Composition (Emulsion Stability when Mixed with Water)

In an environment at room temperature, 99 mL of CIPAC Standard Water D (hardness, 342 ppm) at 30° C. is added to a 100-mL measuring cylinder with a cap, and, from a height of about 8 cm from the water surface, 1 mL of the liquid pesticidal composition is slowly added dropwise. With the cap on, the measuring cylinder is inverted by 180° over 1 second and then inverted back to the original position over 1 second, and this operation is repeated 10 times in total. Then, the measuring cylinder is left to stand in a thermostatic water bath at 30° C. for 24 hours. After this, the state inside the measuring cylinder is visually examined. For each of the liquid pesticidal compositions of Production Examples 1 to 500, no crystal deposition is observed or the number of very small crystals, if any, is less than 100, and therefore, it is considered that crystal deposition or growth tends not to occur, leading to an evaluation that the emulsion stability when mixed with water is excellent.

Another evaluation is carried out under the same conditions except that 99 mL of CIPAC Standard Water D (hardness, 342 ppm) used in the above test is replaced by a mixed liquid of 1.0 mL of AGRI-DEX® (mixture of heavy range paraffinic oil, polyol fatty acid esters, and polyethoxylated derivatives thereof, manufactured by Helena Chemical Company, specific gravity; 0.88) as an adjuvant, 0.5 mL of INTACT™ (mixture of polyethylene glycol, choline chloride, and guar gum, manufactured by Precision Laboratories, specific gravity; 1.06), 4.0 mL of VAPEX™, A VAPORGRIP® XTRA AGENT (mixture of potassium hydrate, and ethanoic acid, manufactured by KALO, Inc., specific gravity; 1.27), 4.4 mL of XTENDIMAX® WITH VAPORGRIP® TECHNOLOGY (dicamba diglycolamine salt, 350 g/L as acid equivalent, manufactured by Bayer, specific gravity; 1.204) as a herbicidal agent, and 89.1 mL of CIPAC Standard Water D (hardness, 342 ppm). Results show that, for each of the liquid pesticidal compositions of Production Examples 1 to 500, no crystal deposition is observed or the number of very small crystals, if any, is less than 100, and therefore, it is considered that crystal deposition or growth tends not to occur, leading to an evaluation that the emulsion stability when mixed with water containing an adjuvant and a herbicide is also excellent.

(3) Herbicidal Efficacy and Crop Injury

The criteria for assessing a herbicidal efficacy and a crop injury, which are shown in the below examples, are shown.

In the assessment of herbicidal efficacy, the efficacy is defined as “0” if the state of budding or growth of test weeds indicates little or no difference compared to that in the case of no treatment at the time of the investigation. The efficacy is defined as “100” if test weeds are completely dead or the budding or growth of test weeds is completely prevented. Hence, the efficacy is classified as “0 to 100”.

In the assessment of crop injuries, the injury is defined as “harmless” if a minimal effect is observed. The injury is defined as “small” if a mild harmful effect is observed. The injury is defined as “medium” if a moderate harmful effect is observed. The injury is defined as “large” if a severe harmful effect is observed.

### Example 1

The weeds (ohonagaaogeito (Palmer amaranth; Amaranthus palmeri), waterhemp (common waterhemp; Amaranthus rudis), butakusa (common ragweed; Ambrosia artemisiaefolia), obutakusa (giant ragweed; Ambrosia trifida), himemukashiyomogi (marestail; Conyza canadensis), shiroza (common lambsquarters; Chenopodium album), hokigi (Kochia; Kochia scoparia), corn (tested assuming volunteer corn) inubie (common barnyardgrass; Echinochloa crus-galli), and akinoenokorogusa (giant foxtail; Setaria faberi) are seeded to a soil-filled plastic pot. On the same day, a mixture of each of the liquid pesticidal compositions of Production Examples 1 to 500 and water is applied to the surface of soil. The application rate is as follow: liquid pesticidal composition; 20 g/ha of the compound X. The spray volume is 140 L/ha. The plants are then cultivated in a greenhouse, and 7 days after the application, soybeans are seeded. 14 days after seeding the soybeans, the effects on the weeds and crop injuries on the soybeans are investigated. Excellent weed control effect is confirmed in case any of each of the liquid pesticidal compositions is used.

### Example 2

The weeds (ohonagaaogeito (Palmer amaranth; Amaranthus palmeri), waterhemp (common waterhemp; Amaranthus rudis), butakusa (common ragweed; Ambrosia artemisiaefolia), obutakusa (giant ragweed; Ambrosia trifida), himemukashiyomogi (marestail; Conyza canadensis), shiroza (common lambsquarters; Chenopodium album), hokigi (Kochia; Kochia scoparia), corn (tested assuming volunteer corn), inubie (common barnyardgrass; Echinochloa crus-galli), and akinoenokorogusa (giant foxtail; Setaria faberi) and soybeans are seeded to a soil-filled plastic pot. On the same day, a mixture of each of the liquid pesticidal compositions of Production Examples 1 to 500 and water is applied to the surface of soil. The application rate is as follow: liquid pesticidal composition; 20 g/ha of the compound X. The spray volume is 140 L/ha. The plants are then cultivated in a greenhouse, and 21 days after the application, the effects on the weeds and crop injuries on the soybeans are investigated. Excellent weed control effect is confirmed in case any of each of the liquid pesticidal compositions is used.

### Example 3

The weeds (ohonagaaogeito (Palmer amaranth; Amaranthus palmeri), waterhemp (common waterhemp; Amaranthus rudis), butakusa (common ragweed; Ambrosia artemisiaefolia), obutakusa (giant ragweed; Ambrosia trifida), himemukashiyomogi (marestail; Conyza canadensis), shiroza (common lambsquarters; Chenopodium album), hokigi (kochia; Kochia scoparia), corn (tested assuming volunteer corn), inubie (common barnyardgrass; Echinochloa crus-galli), and akinoenokorogusa (giant foxtail; Setaria faberi) are seeded to a soil-filled plastic pot. The plants are then cultivated in a greenhouse, and 14 days after the application, a mixture of each of the liquid pesticidal compositions of Production Examples 1 to 500, AGRI-DEX® (mixture of heavy range paraffinic oil, polyol fatty acid esters, and polyethoxylated derivatives thereof, manufactured by Helena Chemical Company, specific gravity; 0.88) and water is applied to the foliage. Each application rate is as follow: liquid pesticidal composition; 20 g/ha of the compound X, AGRI-DEX®; 1,232 g/ha. The spray volume is 140 L/ha. The plants are then cultivated in a greenhouse, and 7 days after the application, soybeans are seeded. 14 days after seeding the soybeans, the effects on the weeds and crop injuries on the soybeans are investigated. Excellent weed control effect is confirmed in case any of each of the liquid pesticidal compositions is used.

### Example 4

The weeds (ohonagaaogeito (Palmer amaranth; Amaranthus palmeri), waterhemp (common waterhemp; Amaranthus rudis), butakusa (common ragweed; Ambrosia artemisiaefolia), obutakusa (giant ragweed; Ambrosia trifida), himemukashiyomogi (marestail; Conyza canadensis), shiroza (common lambsquarters; Chenopodium album), hokigi (Kochia; Kochia scoparia), corn (tested assuming volunteer corn), inubie (common barnyardgrass; Echinochloa crus-galli), and akinoenokorogusa (giant foxtail; Setaria faberi) and soybeans are seeded to a soil-filled plastic pot. The plants are then cultivated in a greenhouse, and 14 days after the application, a mixture of each of the liquid pesticidal compositions of Production Examples 1 to 500, AGRI-DEX® (mixture of heavy range paraffinic oil, polyol fatty acid esters, and polyethoxylated derivatives thereof, manufactured by Helena Chemical Company, specific gravity; 0.88) and water is applied to the foliage. Each application rate is as follow: liquid pesticidal composition; 20 g/ha of the compound X, AGRI-DEX®; 1,232 g/ha. The spray volume is 140 L/ha. The plants are then cultivated in a greenhouse, and 21 days after the application, the effects on the weeds and crop injuries on the soybeans are investigated. Excellent weed control effect is confirmed in case any of each of the liquid pesticidal compositions is used.

### Examples 5-8

Similar procedures to those in Examples 1 to 4 are performed, adding ROUNDUP WEATHERMAX® HERBICIDE (glyphosate potassium salt 660 g/L as acid equivalent, manufactured by Bayer, specific gravity; 1.36) to the mixture to be sprayed. The application rate is as follow: ROUNDUP WEATHERMAX® HERBICIDE; 3,180 g/ha (32 fluid ounce/acre) as the formulated product. Excellent weed control effect is confirmed in case any of each of the liquid pesticidal compositions is used.

### Examples 9-12

Similar procedures to those in Examples 5 to 8 are performed, adding XTENDIMAX® WITH VAPORGRIP® TECHNOLOGY (dicamba diglycolamine salt, 350 g/L as acid equivalent, manufactured by Bayer, specific gravity; 1.204), INTACT™ (mixture of polyethylene glycol, choline chloride, and guar gum, manufactured by Precision Laboratories, specific gravity; 1.06) and VAPEX™, A VAPORGRIP® XTRA AGENT (mixture of potassium hydrate, and ethanoic acid, manufactured by KALO, Inc., specific gravity; 1.27) to the mixture to be sprayed. Each application rate is as follow: XTENDIMAX® WITH VAPORGRIP® TECHNOLOGY; 1,935 g/ha (22 fluid ounce/acre) as the formulated product, INTACT™; 742 g/ha, VAPEX™, A VAPORGRIP® XTRA AGENT; 1,858 g/ha (20 fluid ounce/acre). Excellent weed control effect is confirmed in case any of each of the liquid pesticidal compositions is used.

### Examples 13-16

Similar procedures to those in Examples 1 to 4 are performed, adding ROUNDUP XTEND® WITH VAPORGRIP® TECHNOLOGY (glyphosate monoethanolamine salt 240 g/L as acid equivalent+dicamba diglycolamine salt, 120 g/L as acid equivalent, manufactured by Bayer, specific gravity; 1.225), INTACT™ (mixture of polyethylene glycol, choline chloride, and guar gum, manufactured by Precision Laboratories, specific gravity; 1.06) and VAPEX™, A VAPORGRIP® XTRA AGENT (mixture of potassium hydrate, and ethanoic acid, manufactured by KALO, Inc., specific gravity; 1.27) to the mixture to be sprayed. Each application rate is as follow: ROUNDUP XTEND® WITH VAPORGRIP® TECHNOLOGY; 5,729 g/ha (64 fluid ounce/acre) as the formulated product, INTACT™; 742 g/ha, VAPEX™, A VAPORGRIP® XTRA AGENT; 1,858 g/ha (20 fluid ounce/acre). Excellent weed control effect is confirmed in case any of each of the liquid pesticidal compositions is used.

### Examples 17-32

Similar procedures to those in Examples 1 to 16 are performed, adding VALOR® SX

HERBICIDE (flumioxazin 51 w/w %, manufactured by Valent U.S.A. LLC) to the mixture to be sprayed. The application rate is as follow: VALOR® SX HERBICIDE; 140 g/ha, 210 g/ha, or 280 g/ha as the formulated product. Excellent weed control effect is confirmed in case any of each of the liquid pesticidal compositions is used.

### Examples 33-48

Similar procedures to those in Examples 1 to 16 are performed, adding FIERCE® HERBICIDE (flumioxazin 33.5 w/w %+pyroxasulfone 42.5 w/w %, manufactured by Valent U.S.A. LLC) to the mixture to be sprayed. The application rate is as follow: FIERCE® HERBICIDE; 210 g/ha, 263 g/ha, or 315 g/ha as the formulated product. Excellent weed control effect is confirmed in case any of each of the liquid pesticidal compositions is used.

### Examples 49-96

Similar procedures to those in Examples 1 to 48 are performed, replacing soybeans with corn or cotton.

### Example 97

NIPSIT® (clothianidin 600 g/L, manufactured by Valent U.S.A. LLC) is applied to the seeds of soybeans (variety: GENUITY® ROUNDUP READY 2 YIELD® soybean). The application rate is as follow: NIPSIT®; 206 mL/kg-seed (1.28 fluid ounce/100 pound seeds). A mixture of each of the liquid pesticidal compositions of Production Examples 1 to 500, AGRI-DEX® (mixture of heavy range paraffinic oil, polyol fatty acid esters, and polyethoxylated derivatives thereof, manufactured by Helena Chemical Company, specific gravity; 0.88) and water is applied to the field before seeding the soybeans. Each application rate is as follow: liquid pesticidal composition; 20 g/ha of the compound X, AGRI-DEX®; 1,232 g/ha. The spray volume is 140 L/ha. 7 days after the application, the soybeans are seeded at the field. At 3 true leaf stage of the soybeans, a mixture of ROUNDUP WEATHERMAX® HERBICIDE (glyphosate potassium salt 660 g/L as acid equivalent, manufactured by Bayer, specific gravity; 1.36) and water is applied to the field. The application rate is as follow: ROUNDUP WEATHERMAX® HERBICIDE; 3,180 g/ha (32 fluid ounce/acre) as the formulated product. The spray volume is 140 L/ha. Excellent weed control effect is confirmed in case any of each of the liquid pesticidal compositions is used.

### Example 98

NIP SIT® is applied to the seeds of soybeans in the same manner as Example 97. A mixture of each of the liquid pesticidal compositions of Production Examples 1 to 500, ROUNDUP WEATHERMAX® HERBICIDE (glyphosate potassium salt 660 g/L as acid equivalent, manufactured by Bayer, specific gravity; 1.36), AGRI-DEX® (mixture of heavy range paraffinic oil, polyol fatty acid esters, and polyethoxylated derivatives thereof, manufactured by Helena Chemical Company, specific gravity; 0.88) and water is applied to the field before seeding the soybeans. Each application rate is as follow: liquid pesticidal composition; 20 g/ha of the compound X, ROUNDUP WEATHERMAX® HERBICIDE; 3,180 g/ha (32 fluid ounce/acre) as the formulated product, AGRI-DEX®; 1,232 g/ha. The spray volume is 140 L/ha. 7 days after the application, the soybeans are seeded at the field. At 3 true leaf stage of the soybeans, a mixture of ROUNDUP WEATHERMAX® HERBICIDE (glyphosate potassium salt 660 g/L as acid equivalent, manufactured by Bayer, specific gravity; 1.36) and water is applied to the field. The application rate is as follow: ROUNDUP WEATHERMAX® HERBICIDE; 3,180 g/ha (32 fluid ounce/acre) as the formulated product. The spray volume is 140 L/ha. Excellent weed control effect is confirmed in case any of each of the liquid pesticidal compositions is used.

### Example 99

NIPSIT® is applied to the seeds of soybeans in the same manner as Example 97, followed by seeding to a field. On the next day of the seeding, a mixture of each of the liquid pesticidal compositions of Production Examples 1 to 500, AGRI-DEX® (mixture of heavy range paraffinic oil, polyol fatty acid esters, and polyethoxylated derivatives thereof, manufactured by Helena Chemical Company, specific gravity; 0.88) and water is applied to the field. Each application rate is as follow: liquid pesticidal composition; 20 g/ha of the compound X, AGRI-DEX®; 1,232 g/ha. The spray volume is 140 L/ha. At 3 true leaf stage of the soybeans, a mixture of ROUNDUP WEATHERMAX® HERBICIDE (glyphosate potassium salt 660 g/L as acid equivalent, manufactured by Bayer, specific gravity; 1.36) and water is applied to the field. The application rate is as follow: ROUNDUP WEATHERMAX® HERBICIDE; 3,180 g/ha (32 fluid ounce/acre) as the formulated product. The spray volume is 140 L/ha. Excellent weed control effect is confirmed in case any of each of the liquid pesticidal compositions is used.

### Example 100

NIP SIT® is applied to the seeds of soybeans in the same manner as Example 97, followed by seeding to a field. On the next day of the seeding, a mixture of each of the liquid pesticidal compositions of Production Examples 1 to 500, ROUNDUP WEATHERMAX® HERBICIDE (glyphosate potassium salt 660 g/L as acid equivalent, manufactured by Bayer, specific gravity; 1.36), AGRI-DEX® (mixture of heavy range paraffinic oil, polyol fatty acid esters, and polyethoxylated derivatives thereof, manufactured by Helena Chemical Company, specific gravity; 0.88) and water is applied to the field. Each application rate is as follow: liquid pesticidal composition; 20 g/ha of the compound X, ROUNDUP WEATHERMAX® HERBICIDE; 3,180 g/ha (32 fluid ounce/acre) as the formulated product, AGRI-DEX®; 1,232 g/ha. The spray volume is 140 L/ha. At 3 true leaf stage of the soybeans, a mixture of ROUNDUP WEATHERMAX® HERBICIDE (glyphosate potassium salt 660 g/L as acid equivalent, manufactured by Bayer, specific gravity; 1.36) and water is applied to the field. The application rate is as follow: ROUNDUP WEATHERMAX® HERBICIDE; 3,180 g/ha (32 fluid ounce/acre) as the formulated product. The spray volume is 140 L/ha. Excellent weed control effect is confirmed in case any of each of the liquid pesticidal compositions is used.

### Examples 101-104

In each of Example 97 to 100, XTENDIMAX® WITH VAPORGRIP® TECHNOLOGY (dicamba diglycolamine salt, 350 g/L as acid equivalent, manufactured by Bayer, specific gravity; 1.204), INTACT™ (mixture of polyethylene glycol, choline chloride, and guar gum, manufactured by Precision Laboratories, specific gravity; 1.06) and VAPEX™, A VAPORGRIP® XTRA AGENT (mixture of potassium hydrate, and ethanoic acid, manufactured by KALO, Inc., specific gravity; 1.27) are added to the mixtures to be sprayed, in addition to ROUNDUP WEATHERMAX® HERBICIDE, on the next day of the seeding, or at 3 true leaf stage of the soybeans. Each application rate is as follow: XTENDIMAX® WITH VAPORGRIP® TECHNOLOGY; 1,935 g/ha (22 fluid ounce/acre) as the formulated product, INTACT™; 742 g/ha, VAPEX™, A VAPORGRIP® XTRA AGENT; 1,858 g/ha (20 fluid ounce/acre). Excellent weed control effect is confirmed in case any of each of the liquid pesticidal compositions is used.

### Examples 105-108

In each of Example 97 to 100, ROUNDUP XTEND® WITH VAPORGRIP® TECHNOLOGY (glyphosate monoethanolamine salt 240 g/L as acid equivalent+dicamba diglycolamine salt, 120 g/L as acid equivalent, manufactured by Bayer, specific gravity; 1.225), INTACT™ (mixture of polyethylene glycol, choline chloride, and guar gum, manufactured by Precision Laboratories, specific gravity; 1.06) and VAPEX™, A VAPORGRIP® XTRA AGENT (mixture of potassium hydrate, and ethanoic acid, manufactured by KALO, Inc., specific gravity; 1.27) are added to the mixtures to be sprayed, instead of applying ROUNDUP WEATHERMAX® HERBICIDE, on the next day of the seeding, or at 3 true leaf stage of the soybeans. Each application rate is as follow: ROUNDUP XTEND® WITH VAPORGRIP® TECHNOLOGY; 5,729 g/ha (64 fluid ounce/acre) as the formulated product, INTACT™; 742 g/ha, VAPEX™, A VAPORGRIP® XTRA AGENT; 1,858 g/ha (20 fluid ounce/acre). Excellent weed control effect is confirmed in case any of each of the liquid pesticidal compositions is used.

### Examples 109-120

In each of Examples 97 to 108, INOVATE® (clothianidin 160 g/L+metalaxyl 13 g/L+ipconazole 8 g/L, manufactured by Valent U.S.A. LLC) is used in place of NIPSIT®, and is applied so that the application rate of INOVATE® is 309 mL/100 kg-seeds (4.74 fluid ounce/100 pound seeds). Excellent weed control effect is confirmed in case any of each of the liquid pesticidal compositions is used.

### Examples 121-132

In each of Examples 97 to 108, CRUISERMAXX® VIBRANCE (thiamethoxam 240 g/L+metalaxyl M 36 g/L+fludioxonil 12 g/L+sedaxane 12 g/L, manufactured by Syngenta Ltd.) is used in place of NIPSIT®, and is applied so that the application rate of CRUISERMAXX® VIBRANCE is 235 mL/100 kg-seeds (3.22 fluid ounce/100 pound seeds). Excellent weed control effect is confirmed in case any of each of the liquid pesticidal compositions is used.

### Examples 133-144

In each of Examples 97 to 108, ACCELERON® system (DX-612 (fluxapyroxad 326 g/L, manufactured by Bayer) 31 mL/100 kg-seeds+DX-309 (metalaxyl 313 g/L, manufactured by Bayer) 242 mL/100 kg-seeds (1.5 fluid ounce/100 pound seeds)+DX-109 (pyraclostrobin 200 g/L, manufactured by Bayer) 242 mL/100 kg-seeds (1.5 fluid ounce/100 pound seeds)+IX-104 (imidacloprid 600 g/L, manufactured by Bayer) 515 mL/100 kg-seeds (3.2 fluid ounce/100 pound seeds)) is applied instead of applying NIPSIT® to the seeds of soybean. Excellent weed control effect is confirmed in case any of each of the liquid pesticidal compositions is used.

### Examples 145-192

In each of Examples 97 to 144, seeds of corn or cotton are used in place of seeds of soybean. Excellent weed control effect is confirmed in case any of each of the liquid pesticidal compositions is used.

### Examples 193-288

In the case where any crops are used in Examples 97 to 192, tests are carried out in the same manner as in the Examples except that the crops used in the Examples are replaced with crops having a ROUNDUP READY 2 XTEND® trait. Excellent weed control effect is confirmed in case any of each of the liquid pesticidal compositions is used.

### Examples 289-384

In the case where any crops are used in Examples 97 to 192, tests are carried out in the same manner as in the Examples except that the crops used in the Examples are replaced with crops having both a ROUNDUP READY 2 XTEND® trait and PPO inhibitor-tolerant trait. Excellent weed control effect is confirmed in case any of each of the liquid pesticidal compositions is used.

### Examples 385-480

In the case where any crops are used in Examples 97 to 192, tests are carried out in the same manner as in the Examples except that the crops used in the Examples are replaced with crops having a ROUNDUP READY 2 XTEND® trait, PPO inhibitor-tolerant trait and HPPD inhibitor-tolerant trait. Excellent weed control effect is confirmed in case any of each of the liquid pesticidal compositions is used.

TABLE 1-1

| Production | Pesticidal active | Mass ratio | Water-immiscible | Mass ratio | | Mass ratio | Nonionic | Mass ratio |
|---|---|---|---|---|---|---|---|---|
| Example | ingredient | (w/w %) | solvent | (w/w %) | Ionic surfactant | (w/w %) | surfactant | (w/w %) |
| 1 | Compound X TG | 5.50 | Aromatic 200ND Fluid | 76.50 | Adinol OT-72 | 6.60 | MAKON 12 | 11.40 |
| 2 | Compound X TG | 5.50 | Aromatic 200ND Fluid | 76.50 | Crodafos T5A | 9.60 | Brij S721 | 8.40 |
| 3 | Compound X TG | 5.50 | Aromatic 200 Fluid | 76.50 | Crodafos T6A | 10.80 | Sapogenat T 080 | 7.20 |
| 4 | Compound X TG | 5.50 | Aromatic 100 Fluid | 70.50 | Calsogen 4814 | 8.80 | Crovol M70 | 15.20 |
| 5 | Compound X TG | 5.50 | Aromatic 150ND Fluid | 73.50 | Crodafos CS2A | 14.70 | Synperonic T/908 | 6.30 |
| 6 | Compound X TG | 5.50 | Aromatic 100 Fluid | 79.50 | SULFONIC 100 | 6.50 | Emulsogen TS 200 | 8.50 |
| 7 | Compound X TG | 5.50 | Aromatic 200 Fluid | 82.50 | Crodasinic O | 7.00 | Emulsogen EL 540 | 5.00 |
| 8 | Compound X TG | 5.50 | Aromatic 200 Fluid | 73.50 | Crodafos CS2A | 12.25 | MAKON 12 | 8.75 |
| 9 | Compound X TG | 5.50 | Aromatic 100 Fluid | 82.50 | Multiwet 8269 | 4.20 | Solan 75 | 7.80 |
| 10 | Compound X TG | 5.50 | Aromatic 200 Fluid | 70.50 | BIO-TERGE AS-40 | 7.60 | TOXIMUL 8321 | 16.40 |
| 11 | Compound X TG | 5.50 | Aromatic 150ND Fluid | 82.50 | Crodafos T6A | 5.00 | Sapogenat T 080 | 7.00 |
| 12 | Compound X TG | 5.50 | Aromatic 150 Fluid | 79.50 | Crodafos O3A | 10.00 | Atlas G-1086 | 5.00 |
| 13 | Compound X TG | 5.50 | Aromatic 200 Fluid | 70.50 | SULFONIC 100 | 14.00 | Tween 40 | 10.00 |
| 14 | Compound X TG | 5.50 | Aromatic 200ND Fluid | 70.50 | Crodasinic SM | 14.00 | Synperonic A7 | 10.00 |
| 15 | Compound X TG | 5.50 | Aromatic 200 Fluid | 70.50 | NINATE 411 | 14.80 | Brij O20 | 9.20 |
| 16 | Compound X TG | 5.50 | Aromatic 150 Fluid | 79.50 | Crodafos T6A | 5.50 | Emulsogen EL 400 | 9.50 |
| 17 | Compound X TG | 5.50 | Aromatic 200 Fluid | 79.50 | Multiwet 8269 | 5.00 | Tween 61 | 10.00 |
| 18 | Compound X TG | 5.50 | Aromatic 200 Fluid | 79.50 | Crodasinic O | 6.25 | Emulsogen M | 8.75 |
| 19 | Compound X TG | 5.50 | Aromatic 100 Fluid | 70.50 | BIO-TERGE AS-40 | 16.40 | TOXIMUL 8323 | 7.60 |
| 20 | Compound X TG | 5.50 | Aromatic 150ND Fluid | 79.50 | Phenylsulfonat CA | 7.25 | Crovol M70 | 7.75 |

TABLE 1-2

| | | Mass | | Mass | | Mass | | Mass |
|---|---|---|---|---|---|---|---|---|
| Production | Pesticidal active | ratio | Water-immiscible | ratio | | ratio | Nonionic | ratio |
| Example | ingredient | (w/w %) | solvent | (w/w %) | Ionic surfactant | (w/w %) | surfactant | (w/w %) |
| 21 | Compound X TG | 5.50 | Aromatic 200 Fluid | 76.50 | SULFONIC 100 | 11.70 | Synperonic A7 | 6.30 |
| 22 | Compound X TG | 5.50 | Aromatic 200ND Fluid | 73.50 | Crodafos CO5A | 8.40 | MAKON 8 | 12.60 |
| 23 | Compound X TG | 5.50 | Aromatic 150ND Fluid | 82.50 | Crodasinic O | 8.00 | Emulsogen TS 200 | 4.00 |
| 24 | Compound X TG | 5.50 | Aromatic 150 Fluid | 79.50 | Crodaquat 1207 | 5.75 | Brij 123 | 9.25 |
| 25 | Compound X TG | 5.50 | Aromatic 150 Fluid | 70.50 | Calsogen AR 100 ND | 11.20 | STEP-FLOW LF | 12.80 |
| 26 | Compound X TG | 5.50 | Aromatic 200 Fluid | 79.50 | Crodafos CO5A | 9.75 | MAKON 12 | 5.25 |
| 27 | Compound X TG | 5.50 | Aromatic 200 Fluid | 82.50 | Crodasinic SM | 4.20 | Synperonic A11 | 7.80 |
| 28 | Compound X TG | 5.50 | Aromatic 200 Fluid | 76.50 | Multiwet MO-70R | 8.40 | Myrj S50 | 9.60 |
| 29 | Compound X TG | 5.50 | Aromatic 150 Fluid | 82.50 | Phenylsulfonat CA | 8.00 | Cithrol 10MS | 4.00 |
| 30 | Compound X TG | 5.50 | Aromatic 200ND Fluid | 79.50 | Multiwet MO-70R | 8.00 | Cithrol 4ML | 7.00 |
| 31 | Compound X TG | 5.50 | Aromatic 100 Fluid | 70.50 | Phenylsulfonat CA | 8.80 | Emulsogen EL 300 LM | 15.20 |
| 32 | Compound X TG | 5.50 | Aromatic 200ND Fluid | 70.50 | Crodafos T5A | 15.60 | Synperonic T/908 | 8.40 |
| 33 | Compound X TG | 5.50 | Aromatic 200ND Fluid | 82.50 | NINATE 411 | 5.20 | STEP-FLOW LF | 6.80 |
| 34 | Compound X TG | 5.50 | Aromatic 100 Fluid | 76.50 | Multiwet 8269 | 10.80 | Sapogenat T 110 | 7.20 |
| 35 | Compound X TG | 5.50 | Aromatic 150ND Fluid | 70.50 | Crodafos T6A | 15.20 | Emulsogen TS 160 | 8.80 |
| 36 | Compound X TG | 5.50 | Aromatic 200 Fluid | 82.50 | Crodafos O3A | 4.80 | Synperonic PE/F 87 | 7.20 |
| 37 | Compound X TG | 5.50 | Aromatic 200ND Fluid | 82.50 | Crodafos CS2A | 5.80 | MAKON 12 | 6.20 |
| 38 | Compound X TG | 5.50 | Aromatic 100 Fluid | 82.50 | Multiwet MO-70R | 8.40 | Emulsogen TS 160 | 3.60 |
| 39 | Compound X TG | 5.50 | Aromatic 150 Fluid | 79.50 | Calsogen AR 100 ND | 6.50 | Emulsogen EL 360 | 8.50 |
| 40 | Compound X TG | 5.50 | Aromatic 150ND Fluid | 70.50 | BIO-SOFT N-411 | 10.80 | Synperonic A20 | 13.20 |

TABLE 1-3

| | | Mass | | Mass | | Mass | | Mass |
|---|---|---|---|---|---|---|---|---|
| Production | Pesticidal active | ratio | Water-immiscible | ratio | | ratio | Nonionic | ratio |
| Example | ingredient | (w/w %) | solvent | (w/w %) | Ionic surfactant | (w/w %) | surfactant | (w/w %) |
| 41 | Compound X TG | 5.50 | Aromatic 100 Fluid | 76.50 | Calsogen ARL 100 ND | 6.90 | Emulsogen EL 400 | 11.10 |
| 42 | Compound X TG | 5.50 | Aromatic 150ND Fluid | 70.50 | Phenylsulfonat CA | 15.60 | Crovol CR70G | 8.40 |
| 43 | Compound X TG | 5.50 | Aromatic 150ND Fluid | 76.50 | NINATE 411 | 10.50 | Sapogenat T 180 | 7.50 |
| 44 | Compound X TG | 5.50 | Aromatic 150ND Fluid | 70.50 | Calsogen AR 100 ND | 10.00 | Synperonic T/905 | 14.00 |
| 45 | Compound X TG | 5.50 | Aromatic 150ND Fluid | 79.50 | Calsogen EH | 7.00 | Myrj 540 | 8.00 |
| 46 | Compound X TG | 5.50 | Aromatic 100 Fluid | 70.50 | Crodafos O3A | 12.80 | Synperonic A11 | 11.20 |
| 47 | Compound X TG | 5.50 | Aromatic 200 Fluid | 70.50 | Calsogen ARL 100 ND | 12.80 | Sapogenat T 130 | 11.20 |
| 48 | Compound X TG | 5.50 | Aromatic 200 Fluid | 76.50 | Crodafos 810A | 7.80 | Myrj 58 | 10.20 |
| 49 | Compound X TG | 5.50 | Aromatic 100 Fluid | 82.50 | Crodafos CS2A | 8.00 | Synperonic L11 | 4.00 |
| 50 | Compound X TG | 5.50 | Aromatic 200 Fluid | 73.50 | Crodafos T6A | 13.30 | Cresmer AS | 7.70 |
| 51 | Compound X TG | 5.50 | Aromatic 150ND Fluid | 79.50 | BIO-TERGE AS-40 | 4.50 | Emulsogen TS 600 | 10.50 |
| 52 | Compound X TG | 5.50 | Aromatic 150 Fluid | 79.50 | Crodaquat TES | 6.00 | Synperonic PE/F 68 | 9.00 |
| 53 | Compound X TG | 5.50 | Aromatic 150ND Fluid | 79.50 | Crodafos T5A | 6.75 | Brij S20 | 8.25 |
| 54 | Compound X TG | 5.50 | Aromatic 200ND Fluid | 70.50 | Calsogen EH | 7.60 | Brij S100 | 16.40 |
| 55 | Compound X TG | 5.50 | Aromatic 150ND Fluid | 82.50 | BIO-SOFT N-411 | 7.40 | Myrj S20 | 4.60 |
| 56 | Compound X TG | 5.50 | Aromatic 150 Fluid | 82.50 | Crodasinic O | 6.00 | Solan 60 | 6.00 |
| 57 | Compound X TG | 5.50 | Aromatic 100 Fluid | 76.50 | Crodaquat TES | 9.30 | Tween 80 | 8.70 |
| 58 | Compound X TG | 5.50 | Aromatic 150 Fluid | 76.50 | Phenylsulfonat CA | 6.00 | Emulsogen TS 200 | 12.00 |
| 59 | Compound X TG | 5.50 | Aromatic 200 Fluid | 79.50 | Crodafos 810A | 10.25 | Sapogenat T 500 | 4.75 |
| 60 | Compound X TG | 5.50 | Aromatic 200 Fluid | 79.50 | BIO-SOFT N-411 | 9.75 | Synperonic A11 | 5.25 |

TABLE 1-4

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 61 | Compound X TG | 5.50 | Aromatic 150ND Fluid | 82.50 | Calsogen 4814 | 8.20 | Myrj S8 | 3.80 |
| 62 | Compound X TG | 5.50 | Aromatic 150 Fluid | 70.50 | Calsogen ARL 100 ND | 12.40 | Brij O10 | 11.60 |
| 63 | Compound X TG | 5.50 | Aromatic 100 Fluid | 82.50 | Phenylsulfonat CAL | 7.60 | Brij C20 | 4.40 |
| 64 | Compound X TG | 5.50 | Aromatic 150ND Fluid | 76.50 | Calsogen 4814 | 10.20 | MAKON 6 | 7.80 |
| 65 | Compound X TG | 5.50 | Aromatic 150 Fluid | 70.50 | Crodasinic O | 9.60 | MAKON 12 | 14.40 |
| 66 | Compound X TG | 5.50 | Aromatic 150ND Fluid | 82.50 | Calsogen ARL 100 ND | 3.80 | Synperonic PE/P 84 | 8.20 |
| 67 | Compound X TG | 5.50 | Aromatic 100 Fluid | 76.50 | Crodaquat TES | 12.00 | Emulsogen TS 160 | 6.00 |
| 68 | Compound X TG | 5.50 | Aromatic 200ND Fluid | 73.50 | Crodaquat TES | 8.40 | Cresmer AS | 12.60 |
| 69 | Compound X TG | 5.50 | Aromatic 200ND Fluid | 79.50 | Phenylsulfonat CA | 9.50 | Synperonic T/905 | 5.50 |
| 70 | Compound X TG | 5.50 | Aromatic 150ND Fluid | 73.50 | Adinol OT-72 | 10.15 | MAKON OP-9 | 10.85 |
| 71 | Compound X TG | 5.50 | Aromatic 100 Fluid | 73.50 | NINATE 411 | 12.95 | Emulsogen EL 540 | 8.05 |
| 72 | Compound X TG | 5.50 | Aromatic 100 Fluid | 76.50 | Calsogen EH | 7.80 | Emulsogen EL 540 | 10.20 |
| 73 | Compound X TG | 5.50 | Aromatic 200ND Fluid | 79.50 | Crodasinic SM | 8.75 | Synperonic L11 | 6.25 |
| 74 | Compound X TG | 5.50 | Aromatic 100 Fluid | 73.50 | Multiwet 8269 | 9.10 | TOXIMUL L-62 | 11.90 |
| 75 | Compound X TG | 5.50 | Aromatic 200 Fluid | 8250 | BIO-SOFT N-411 | 4.40 | Brij C10 | 7.60 |
| 76 | Compound X TG | 5.50 | Aromatic 150ND Fluid | 76.50 | BIO-TERGE AS-40 | 6.30 | Emulsogen M | 11.70 |
| 77 | Compound X TG | 5.50 | Aromatic 100 Fluid | 76.50 | Calsogen AR 100 ND | 10.50 | Emulsogen TS 540 | 7.50 |
| 78 | Compound X TG | 5.50 | Aromatic 150ND Fluid | 82.50 | Crodafos CS2A | 4.80 | MAKON 10 | 7.20 |
| 79 | Compound X TG | 5.50 | Aromatic 150ND Fluid | 73.50 | Calsogen EH | 12.60 | Brij L23 | 8.40 |
| 80 | Compound X TG | 5.50 | Aromatic 200 Fluid | 73.50 | NINATE 411 | 6.65 | Cirrasol G-1086 | 14.35 |

TABLE 1-5

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 81 | Compound X TG | 5.50 | Aromatic 150ND Fluid | 79.50 | Calsogen AR 100 ND | 9.50 | Synperonic 13/9 | 5.50 |
| 82 | Compound X TG | 5.50 | Aromatic 200 Fluid | 73.50 | Adinol OT-72 | 8.40 | Myrj S20 | 12.60 |
| 83 | Compound X TG | 5.50 | Aromatic 200 Fluid | 76.50 | BIO-SOFT D-40 | 12.60 | Cirrasol G-1086 | 5.40 |
| 84 | Compound X TG | 5.50 | Aromatic 200 Fluid | 79.50 | Calsogen 4814 | 8.75 | Myrj S8 | 6.25 |
| 85 | Compound X TG | 5.50 | Aromatic 100 Fluid | 73.50 | Crodafos T5A | 11.20 | Brij S10 | 9.80 |
| 86 | Compound X TG | 5.50 | Aromatic 200ND Fluid | 70.50 | Crodafos O3A | 11.60 | Myrj S40 | 12.40 |
| 87 | Compound X TG | 5.50 | Aromatic 200 Fluid | 82.50 | Crodaquat 1207 | 6.80 | Myrj S50 | 5.20 |
| 88 | Compound X TG | 5.50 | Aromatic 150 Fluid | 70.50 | Calsogen ARL 100 ND | 14.40 | Arlatone TV | 9.60 |
| 89 | Compound X TG | 5.50 | Aromatic 200 Fluid | 82.50 | Adinol OT-72 | 6.40 | Cithrol 4ML | 5.60 |
| 90 | Compound X TG | 5.50 | Aromatic 200 Fluid | 79.50 | BIO-SOFT N-300 | 9.25 | Synperonic 91/10 | 5.75 |
| 91 | Compound X TG | 5.50 | Aromatic 200 Fluid | 79.50 | Multiwet 8269 | 4.75 | Synperonic A4 | 10.25 |
| 92 | Compound X TG | 5.50 | Aromatic 200 Fluid | 76.50 | Crodasinic SM | 11.10 | Cirrasol 6-1096 | 6.90 |
| 93 | Compound X TG | 5.50 | Aromatic 100 Fluid | 79.50 | Crodaquat TES | 6.75 | Myrj S100 | 8.25 |
| 94 | Compound X TG | 5.50 | Aromatic 200ND Fluid | 79.50 | Multiwet MO-70R | 10.50 | Tween 60 | 4.50 |
| 95 | Compound X TG | 5.50 | Aromatic 100 Fluid | 82.50 | Calsogen 4814 | 5.20 | Tween 61 | 6.80 |
| 96 | Compound X TG | 5.50 | Aromatic 150ND Fluid | 70.50 | BIO-SOFT N-300 | 16.80 | Emulsogen EL 360 | 7.20 |
| 97 | Compound X TG | 5.50 | Aromatic 200ND Fluid | 70.50 | BIO-SOFT N-300 | 10.40 | Synperonic 13/10 | 13.60 |
| 98 | Compound X TG | 5.50 | Aromatic 150ND Fluid | 70.50 | Calsogen EH | 9.60 | Myrj S20 | 14.40 |
| 99 | Compound X TG | 5.50 | Aromatic 200ND Fluid | 82.50 | BIO-TERGE AS-40 | 5.60 | STEP-FLOW 26 | 6.40 |
| 100 | Compound X TG | 5.50 | Aromatic 200ND Fluid | 76.50 | Crodasinic O | 12.00 | Synperonic A11 | 6.00 |

TABLE 1-6

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 101 | Compound X TG | 5.50 | Aromatic 200ND Fluid | 73.50 | Phenylsulfonat CA | 10.85 | Emulsogen TS 160 | 10.15 |
| 102 | Compound X TG | 5.50 | Aromatic 100 Fluid | 73.50 | Crodafos T6A | 10.50 | Brij S721 | 10.50 |
| 103 | Compound X TG | 5.50 | Aromatic 150ND Fluid | 70.50 | Calsogen 4814 | 8.40 | Cresmer A11 | 15.60 |
| 104 | Compound X TG | 5.50 | Aromatic 200ND Fluid | 73.50 | Calsogen 4814 | 14.00 | Sapogenat T 500 | 7.00 |
| 105 | Compound X TG | 5.50 | Aromatic 200ND Fluid | 73.50 | Phenylsulfonat CAL | 9.80 | Cresmer A20 | 11.20 |
| 106 | Compound X TG | 5.50 | Aromatic 100 Fluid | 82.50 | Calsogen 4814 | 8.20 | Synperonic 91/10 | 3.80 |
| 107 | Compound X TG | 5.50 | Aromatic 200 Fluid | 73.50 | Calsogen ARL 100 ND | 8.75 | Synperonic T/304 | 12.25 |
| 108 | Compound X TG | 5.50 | Aromatic 150ND Fluid | 82.50 | Crodafos T5A | 8.20 | Atlas 6-1086 | 3.80 |
| 109 | Compound X TG | 5.50 | Aromatic 150ND Fluid | 82.50 | Crodafos 16A | 7.60 | Synperonic 13/12 | 4.40 |
| 110 | Compound X TG | 5.50 | Aromatic 100 Fluid | 79.50 | BIO-SOFT N-411 | 8.75 | Synperonic 13/10 | 6.25 |
| 111 | Compound X TG | 5.50 | Aromatic 150 Fluid | 79.50 | Crodafos O3A | 6.25 | Brij C20 | 8.75 |
| 112 | Compound X TG | 5.50 | Aromatic 150ND Fluid | 73.50 | Calsogen EH | 6.65 | Synperonic PE/P 84 | 14.35 |
| 113 | Compound X TG | 5.50 | Aromatic 200ND Fluid | 82.50 | Calsogen 4814 | 8.20 | MAKON 4 | 3.80 |
| 114 | Compound X TG | 5.50 | Aromatic 150 Fluid | 70.50 | Adinol OT-72 | 11.20 | Sapogenat 1080 | 12.80 |
| 115 | Compound X TG | 5.50 | Aromatic 150ND Fluid | 70.50 | Crodafos CO5A | 8.80 | Brij S721 | 15.20 |
| 116 | Compound X TG | 5.50 | Aromatic 100 Fluid | 79.50 | Crodafos T6A | 8.50 | Cresmer A20 | 6.50 |
| 117 | Compound X TG | 5.50 | Aromatic 200 Fluid | 70.50 | BIO-TERGE AS-40 | 15.20 | Emulsogen TS 600 | 8.80 |
| 118 | Compound X TG | 5.50 | Aromatic 150 Fluid | 70.50 | Crodafos CO5A | 14.80 | Synperonic PE/P 105 | 9.20 |
| 119 | Compound X TG | 5.50 | Aromatic 150ND Fluid | 82.50 | Crodafos CS2A | 7.80 | Tween 60 | 4.20 |
| 120 | Compound X TG | 5.50 | Aromatic 200 Fluid | 79.50 | Crodafos O3A | 6.50 | Myrj S50 | 8.50 |

TABLE 1-7

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 121 | Compound X TG | 5.50 | Aromatic 100 Fluid | 79.50 | SULFONIC 100 | 8.25 | MAKON 6 | 6.75 |
| 122 | Compound X TG | 5.50 | Aromatic 150ND Fluid | 70.50 | Phenylsulfonat CAL | 11.20 | Cresmer A20 | 12.80 |
| 123 | Compound X TG | 5.50 | Aromatic 100 Fluid | 70.50 | Multiwet MO-70R | 11.20 | Emulsogen TS 290 | 12.80 |
| 124 | Compound X TG | 5.50 | Aromatic 150 Fluid | 73.50 | SULFONIC 100 | 7.70 | Sapogenat T 300 | 13.30 |
| 125 | Compound X TG | 5.50 | Aromatic 200 Fluid | 76.50 | Crodafos O3A | 6.60 | Cresmer A9 | 11.40 |
| 126 | Compound X TG | 5.50 | Aromatic 100 Fluid | 70.50 | Crodaquat 1207 | 16.00 | Tween 61 | 8.00 |
| 127 | Compound X TG | 5.50 | Aromatic 200 Fluid | 76.50 | BIO-TERGE AS-40 | 6.30 | Brij O20 | 11.70 |
| 128 | Compound X TG | 5.50 | Aromatic 200ND Fluid | 79.50 | BIO-TERGE AS-40 | 10.25 | Sapogenat T 110 | 4.75 |
| 129 | Compound X TG | 5.50 | Aromatic 150ND Fluid | 76.50 | Crodafos O3A | 7.50 | Cresmer A5 | 10.50 |
| 130 | Compound X TG | 5.50 | Aromatic 150ND Fluid | 76.50 | BIO-SOFT N-300 | 12.60 | Sapogenat T 060 | 5.40 |
| 131 | Compound X TG | 5.50 | Aromatic 200 Fluid | 73.50 | Multiwet MO-70R | 9.80 | Synperonic L11 | 11.20 |
| 132 | Compound X TG | 5.50 | Aromatic 150 Fluid | 79.50 | Adinol OT-72 | 8.50 | Sapogenat T 080 | 6.50 |
| 133 | Compound X TG | 5.50 | Aromatic 150ND Fluid | 76.50 | Adinol OT-72 | 6.00 | Brij L4 | 12.00 |
| 134 | Compound X TG | 5.50 | Aromatic 150 Fluid | 73.50 | Calsogen AR 100 ND | 10.15 | Tween 81 | 10.85 |
| 135 | Compound X TG | 5.50 | Aromatic 200ND Fluid | 82.50 | SULFONIC 100 | 7.00 | Sapogenat T 130 | 5.00 |
| 136 | Compound X TG | 5.50 | Aromatic 150ND Fluid | 79.50 | Phenylsulfonat CAL | 9.75 | Crovol CR706 | 5.25 |
| 137 | Compound X TG | 5.50 | Aromatic 200ND Fluid | 70.50 | NINATE 411 | 10.40 | MAKON 8 | 13.60 |
| 138 | Compound X TG | 5.50 | Aromatic 150 Fluid | 76.50 | Crodaquat TES | 8.10 | Brij S10 | 9.90 |
| 139 | Compound X TG | 5.50 | Aromatic 150 Fluid | 73.50 | Crodasinic O | 14.00 | Synperonic A4 | 7.00 |
| 140 | Compound X TG | 5.50 | Aromatic 100 Fluid | 79.50 | Crodafos CS2A | 6.75 | Atlox 1045A | 8.25 |

TABLE 1-8

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 141 | Compound X TG | 5.50 | Aromatic 150ND Fluid | 76.50 | Crodaquat TES | 8.40 | Crovol PK70 | 9.60 |
| 142 | Compound X TG | 5.50 | Aromatic 150ND Fluid | 82.50 | Calsogen AR 100 ND | 5.40 | Emulsogen TS 600 | 6.60 |
| 143 | Compound X TG | 5.50 | Aromatic 150ND Fluid | 76.50 | Crodasinic SM | 9.30 | Synperonic PE/F 108 | 8.70 |
| 144 | Compound X TG | 5.50 | Aromatic 150 Fluid | 70.50 | Calsogen 4814 | 12.80 | Cithrol 4ML | 11.20 |
| 145 | Compound X TG | 5.50 | Aromatic 150 Fluid | 82.50 | Crodafos CO5A | 6.80 | Tween 40 | 5.20 |
| 146 | Compound X TG | 5.50 | Aromatic 200ND Fluid | 73.50 | Calsogen 4814 | 9.10 | Crovol PK70 | 11.90 |
| 147 | Compound X TG | 5.50 | Aromatic 150 Fluid | 76.50 | Calsogen EH | 10.20 | Emulsogen EL 300 LM | 7.80 |
| 148 | Compound X TG | 5.50 | Aromatic 200ND Fluid | 73.50 | Multiwet 8269 | 11.20 | Crovol CR70G | 9.80 |
| 149 | Compound X TG | 5.50 | Aromatic 150ND Fluid | 70.50 | Crodasinic O | 8.40 | Sapogenat T 300 | 15.60 |
| 150 | Compound X TG | 5.50 | Aromatic 200ND Fluid | 76.50 | BIO-SOFT D-40 | 6.30 | Synperonic PE/F 87 | 11.70 |
| 151 | Compound X TG | 5.50 | Aromatic 200 Fluid | 82.50 | Phenylsulfonat CAL | 7.60 | Sapogenat T 500 | 4.40 |
| 152 | Compound X TG | 5.50 | Aromatic 150ND Fluid | 82.50 | SULFONIC 100 | 5.60 | Brij L4 | 6.40 |
| 153 | Compound X TG | 5.50 | Aromatic 200ND Fluid | 76.50 | Adinol OT-72 | 12.30 | MAKON 8 | 5.70 |
| 154 | Compound X TG | 5.50 | Aromatic 150ND Fluid | 70.50 | Phenylsulfonat CA | 14.40 | Brij C20 | 9.60 |
| 155 | Compound X TG | 5.50 | Aromatic 150 Fluid | 73.50 | BIO-SOFT N-411 | 10.50 | Solan 60 | 10.50 |
| 156 | Compound X TG | 5.50 | Aromatic 150ND Fluid | 73.50 | SULFONIC 100 | 13.30 | Synperonic PE/L 64 | 7.70 |
| 157 | Compound X TG | 5.50 | Aromatic 150 Fluid | 82.50 | NINATE 411 | 5.60 | Cresmer A20 | 6.40 |
| 158 | Compound X TG | 5.50 | Aromatic 150ND Fluid | 76.50 | Phenylsulfonat CAL | 11.40 | Arlatone TV | 6.60 |
| 159 | Compound X TG | 5.50 | Aromatic 200ND Fluid | 82.50 | SULFONIC 100 | 3.80 | Brij O20 | 8.20 |
| 160 | Compound X TG | 5.50 | Aromatic 100 Fluid | 73.50 | Crodasinic SM | 12.95 | Emulsogen TS 200 | 8.05 |

TABLE 1-9

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 161 | Compound X TG | 5.50 | Aromatic 200ND Fluid | 76.50 | Crodasinic O | 8.10 | TOXIMUL L-62 | 9.90 |
| 162 | Compound X TG | 5.50 | Aromatic 150 Fluid | 70.50 | Crodafos T5A | 10.40 | Sapogenat T 040 | 13.60 |
| 163 | Compound X TG | 5.50 | Aromatic 200 Fluid | 79.50 | Crodaquat 1207 | 10.25 | Synperonic PE/P 84 | 4.75 |
| 164 | Compound X TG | 5.50 | Aromatic 200ND Fluid | 82.50 | Crodafos CO5A | 8.00 | Synperonic 13/8 | 4.00 |
| 165 | Compound X TG | 5.50 | Aromatic 200 Fluid | 70.50 | BIO-SOFT N-411 | 15.20 | Crovol PK70 | 8.80 |
| 166 | Compound X TG | 5.50 | Aromatic 200ND Fluid | 73.50 | Adinol OT-72 | 11.55 | Emulsogen TS 100 | 9.45 |
| 167 | Compound X TG | 5.50 | Aromatic 100 Fluid | 70.50 | Calsogen 4814 | 14.40 | Brij S20 | 9.60 |
| 168 | Compound X TG | 5.50 | Aromatic 150 Fluid | 76.50 | Crodafos O3A | 5.40 | Synperonic T/304 | 12.60 |
| 169 | Compound X TG | 5.50 | Aromatic 150 Fluid | 76.50 | Crodafos T5A | 12.30 | Tween 65 | 5.70 |
| 170 | Compound X TG | 5.50 | Aromatic 200 Fluid | 79.50 | Crodafos O3A | 10.50 | Cirrasol G-1086 | 4.50 |
| 171 | Compound X TG | 5.50 | Aromatic 200ND Fluid | 82.50 | NINATE 411 | 7.80 | Cresmer A11 | 4.20 |
| 172 | Compound X TG | 5.50 | Aromatic 200ND Fluid | 79.50 | NINATE 411 | 9.00 | Tween 65 | 6.00 |
| 173 | Compound X TG | 5.50 | Aromatic 100 Fluid | 73.50 | Multiwet 8269 | 11.90 | Sapogenat T 180 | 9.10 |
| 174 | Compound X TG | 5.50 | Aromatic 100 Fluid | 73.50 | Crodasinic SM | 14.70 | Tween 65 | 6.30 |
| 175 | Compound X TG | 5.50 | Aromatic 200ND Fluid | 70.50 | Crodafos T6A | 9.20 | Sapogenat T 110 | 14.80 |
| 176 | Compound X TG | 5.50 | Aromatic 200ND Fluid | 76.50 | BIO-SOFT N-411 | 9.00 | Brij S100 | 9.00 |
| 177 | Compound X TG | 5.50 | Aromatic 200 Fluid | 73.50 | BIO-SOFT N-300 | 7.00 | TOXIMUL 8323 | 14.00 |
| 178 | Compound X TG | 5.50 | Aromatic 200ND Fluid | 76.50 | Crodasinic SM | 11.70 | Cithrol 4MS | 6.30 |
| 179 | Compound X TG | 5.50 | Aromatic 100 Fluid | 82.50 | Crodafos CO5A | 6.60 | Atlas G-1096 | 5.40 |
| 180 | Compound X TG | 5.50 | Aromatic 100 Fluid | 70.50 | Crodafos O3A | 11.60 | Synperonic T/304 | 12.40 |

TABLE 1-10

| | | Mass | | Mass | | Mass | | Mass |
|---|---|---|---|---|---|---|---|---|
| Production | Pesticidal active | ratio | Water-immiscible | ratio | | ratio | | ratio |
| Example | ingredient | (w/w %) | solvent | (w/w %) | Ionic surfactant | (w/w %) | Nonionic surfactant | (w/w %) |
| 181 | Compound X TG | 5.50 | Aromatic 200ND Fluid | 79.50 | Crodafos 810A | 7.00 | Emulsogen EL 300 LM | 8.00 |
| 182 | Compound X TG | 5.50 | Aromatic 200ND Fluid | 70.50 | Phenylsulfonat CAL | 9.60 | Synperonic PE/F 108 | 14.40 |
| 183 | Compound X TG | 5.50 | Aromatic 150ND Fluid | 73.50 | Crodafos T5A | 11.55 | Sapogenat 1080 | 9.45 |
| 184 | Compound X TG | 5.50 | Aromatic 100 Fluid | 73.50 | Calsogen ARL 100 ND | 12.95 | Brij O10 | 8.05 |
| 185 | Compound X TG | 5.50 | Aromatic 200ND Fluid | 82.50 | Crodafos T6A | 8.40 | Tween 80 | 3.60 |
| 186 | Compound X TG | 5.50 | Aromatic 100 Fluid | 79.50 | Multiwet MO-70R | 4.75 | Brij S721 | 10.25 |
| 187 | Compound X TG | 5.50 | Aromatic 100 Fluid | 76.50 | Crodafos 810A | 9.00 | Synperonic A4 | 9.00 |
| 188 | Compound X TG | 5.50 | Aromatic 100 Fluid | 73.50 | BIO-SOFT N-300 | 14.70 | Brij S20 | 6.30 |
| 189 | Compound X TG | 5.50 | Aromatic 200ND Fluid | 79.50 | Multiwet 8269 | 6.00 | Brij C10 | 9.00 |
| 190 | Compound X TG | 5.50 | Aromatic 200ND Fluid | 79.50 | Crodaquat 1207 | 5.00 | Tween 40 | 10.00 |
| 191 | Compound X TG | 5.50 | Aromatic 150ND Fluid | 76.50 | Multiwet 8269 | 10.50 | Atlas G-1096 | 7.50 |
| 192 | Compound X TG | 5.50 | Aromatic 150ND Fluid | 70.50 | Multiwet 8269 | 16.00 | Cresmer A5 | 8.00 |
| 193 | Compound X TG | 5.50 | Aromatic 100 Fluid | 82.50 | Calsogen EH | 5.00 | Synperonic PE/L 64 | 7.00 |
| 194 | Compound X TG | 5.50 | Aromatic 200ND Fluid | 70.50 | Crodafos 810A | 8.40 | Atlas G-1096 | 15.60 |
| 195 | Compound X TG | 5.50 | Aromatic 100 Fluid | 73.50 | BIO-SOFT D-40 | 12.60 | MAKON 6 | 8.40 |
| 196 | Compound X TG | 5.50 | Aromatic 150 Fluid | 79.50 | Crodasinic SM | 7.50 | Brij S100 | 7.50 |
| 197 | Compound X TG | 5.50 | Aromatic 150ND Fluid | 70.50 | Adinol OT-72 | 16.00 | Span 20 | 8.00 |
| 198 | Compound X TG | 5.50 | Aromatic 150ND Fluid | 76.50 | Calsogen AR 100 ND | 11.10 | Synperonic PE/L 64 | 6.90 |
| 199 | Compound X TG | 5.50 | Aromatic 100 Fluid | 73.50 | Multiwet MO-70R | 11.90 | Synperonic A11 | 9.10 |
| 200 | Compound X TG | 5.50 | Aromatic 150 Fluid | 70.50 | BIO-SOFT N-300 | 16.80 | Emulsogen TS 100 | 7.20 |

TABLE 1-11

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 201 | Compound X TG | 5.50 | Aromatic 200ND Fluid | 73.50 | Crodafos 810A | 12.25 | Cithrol 4MS | 8.75 |
| 202 | Compound X TG | 5.50 | Aromatic 150 Fluid | 70.50 | NINATE 411 | 12.80 | Sapogenat T 180 | 11.20 |
| 203 | Compound X TG | 5.50 | Aromatic 100 Fluid | 76.50 | Crodafos T5A | 10.20 | Synperonic PE/F 127 | 7.80 |
| 204 | Compound X TG | 5.50 | Aromatic 150ND Fluid | 73.50 | Crodaquat TES | 6.30 | Emulsogen TS 600 | 14.70 |
| 205 | Compound X TG | 5.50 | Aromatic 100 Fluid | 79.50 | BIO-SOFT D-40 | 10.25 | Sapogenat T 060 | 4.75 |
| 206 | Compound X TG | 5.50 | Aromatic 200ND Fluid | 76.50 | BIO-SOFT N-300 | 9.30 | TOXIMUL 8323 | 8.70 |
| 207 | Compound X TG | 5.50 | Aromatic 200 Fluid | 70.50 | Multiwet MO-70R | 8.80 | Synperonic PE/F 87 | 15.20 |
| 208 | Compound X TG | 5.50 | Aromatic 150 Fluid | 82.50 | BIO-SOFT N-300 | 5.20 | Arlatone TV | 6.80 |
| 209 | Compound X TG | 5.50 | Aromatic 200ND Fluid | 79.50 | Phenylsulfonat CAL | 7.50 | Emulsogen TS 290 | 7.50 |
| 210 | Compound X TG | 5.50 | Aromatic 200ND Fluid | 76.50 | Calsogen AR 100 ND | 8.10 | TOXIMUL 8321 | 9.90 |
| 211 | Compound X TG | 5.50 | Aromatic 200 Fluid | 82.50 | Phenylsulfonat CA | 4.00 | Cresmer A5 | 8.00 |
| 212 | Compound X TG | 5.50 | Aromatic 200ND Fluid | 76.50 | SULFONIC 100 | 5.70 | Solan 60 | 12.30 |
| 213 | Compound X TG | 5.50 | Aromatic 150ND Fluid | 73.50 | BIO-TERGE AS-40 | 9.80 | Tween 60 | 11.20 |
| 214 | Compound X TG | 5.50 | Aromatic 150 Fluid | 82.50 | BIO-SOFT D-40 | 4.60 | MAKON 8 | 7.40 |
| 215 | Compound X TG | 5.50 | Aromatic 150 Fluid | 76.50 | BIO-TERGE AS-40 | 9.90 | Sapogenat T 040 | 8.10 |
| 216 | Compound X TG | 5.50 | Aromatic 150ND Fluid | 82.50 | Multiwet MO-70R | 7.40 | Sapogenat T 060 | 4.60 |
| 217 | Compound X TG | 5.50 | Aromatic 150 Fluid | 79.50 | Phenylsulfonat CA | 7.25 | Atlas G-1096 | 7.75 |
| 218 | Compound X TG | 5.50 | Aromatic 200ND Fluid | 82.50 | Calsogen ARL 100 ND | 4.80 | Crovol CR70G | 7.20 |
| 219 | Compound X TG | 5.50 | Aromatic 200 Fluid | 82.50 | Crodaquat TES | 7.20 | TOXIMUL L-62 | 4.80 |
| 220 | Compound X TG | 5.50 | Aromatic 200 Fluid | 82.50 | BIO-SOFT N-411 | 7.20 | Synperonic A3 | 4.80 |

TABLE 1-12

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 221 | Compound X TG | 5.50 | Aromatic 100 Fluid | 76.50 | NINATE 411 | 8.70 | Crovol M70 | 9.30 |
| 222 | Compound X TG | 5.50 | Aromatic 150 Fluid | 76.50 | BIO-SOFT N-411 | 7.20 | Synperonic T/908 | 10.80 |
| 223 | Compound X TG | 5.50 | Aromatic 150ND Fluid | 73.50 | Crodafos CO5A | 7.00 | Tween 80 | 14.00 |
| 224 | Compound X TG | 5.50 | Aromatic 200ND Fluid | 70.50 | BIO-SOFT N-411 | 14.80 | Atlox 1045A | 9.20 |
| 225 | Compound X TG | 5.50 | Aromatic 200 Fluid | 79.50 | Crodafos CO5A | 8.50 | Synperonic 13/8 | 6.50 |
| 226 | Compound X TG | 5.50 | Aromatic 200 Fluid | 82.50 | Adinol OT-72 | 6.20 | Tween 20 | 5.80 |
| 227 | Compound X TG | 5.50 | Aromatic 150 Fluid | 73.50 | BIO-TERGE AS-40 | 14.35 | Myrj S100 | 6.65 |
| 228 | Compound X TG | 5.50 | Aromatic 200 Fluid | 76.50 | SULFONIC 100 | 7.20 | Emulsogen TS 290 | 10.80 |
| 229 | Compound X TG | 5.50 | Aromatic 200ND Fluid | 79.50 | BIO-SOFT D-40 | 8.00 | Emulsogen TS 160 | 7.00 |
| 230 | Compound X TG | 5.50 | Aromatic 150 Fluid | 70.50 | Crodafos CS2A | 10.40 | Emulsogen EL 400 | 13.60 |
| 231 | Compound X TG | 5.50 | Aromatic 200 Fluid | 82.50 | BIO-TERGE AS-40 | 6.40 | MAKON OP-9 | 5.60 |
| 232 | Compound X TG | 5.50 | Aromatic 150 Fluid | 76.50 | Crodasinic 0 | 9.30 | Tween 85 | 8.70 |
| 233 | Compound X TG | 5.50 | Aromatic 200ND Fluid | 76.50 | BIO-TERGE AS-40 | 6.90 | Emulsogen EL 360 | 11.10 |
| 234 | Compound X TG | 5.50 | Aromatic 150 Fluid | 82.50 | Crodafos 810A | 6.20 | Tween 65 | 5.80 |
| 235 | Compound X TG | 5.50 | Aromatic 150ND Fluid | 73.50 | BIO-SOFT N-300 | 7.35 | Sapogenat T 110 | 13.65 |
| 236 | Compound X TG | 5.50 | Aromatic 150 Fluid | 82.50 | Crodaquat TES | 5.00 | Brij L23 | 7.00 |
| 237 | Compound X TG | 5.50 | Aromatic 200 Fluid | 73.50 | Crodaquat 1207 | 11.55 | Brij S100 | 9.45 |
| 238 | Compound X TG | 5.50 | Aromatic 200 Fluid | 79.50 | BIO-SOFT N-300 | 5.50 | Tween 81 | 9.50 |
| 239 | Compound X TG | 5.50 | Aromatic 200 Fluid | 79.50 | BIO-SOFT D-40 | 6.00 | Sapogenat T 040 | 9.00 |
| 240 | Compound X TG | 5.50 | Aromatic 200 Fluid | 76.50 | Crodafos T6A | 12.30 | Emulsogen EL 200 | 5.70 |

TABLE 1-13

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 241 | Compound X TG | 5.50 | Aromatic 150 Fluid | 82.50 | Crodaquat TES | 4.40 | Cithrol 4MS | 7.60 |
| 242 | Compound X TG | 5.50 | Aromatic 150ND Fluid | 79.50 | SULFONIC 100 | 5.25 | Tween 80 | 9.75 |
| 243 | Compound X TG | 5.50 | Aromatic 200 Fluid | 73.50 | Crodaquat 1207 | 7.00 | Brij O20 | 14.00 |
| 244 | Compound X TG | 5.50 | Aromatic 150ND Fluid | 79.50 | Crodafos T5A | 9.75 | Synperonic 13/12 | 5.25 |
| 245 | Compound X TG | 5.50 | Aromatic 200ND Fluid | 82.50 | Crodafos O3A | 6.80 | Brij S100 | 5.20 |
| 246 | Compound X TG | 5.50 | Aromatic 150 Fluid | 73.50 | Phenylsulfonat CA | 10.50 | Emulsogen EL 200 | 10.50 |
| 247 | Compound X TG | 5.50 | Aromatic 200 Fluid | 82.50 | BIO-SOFT D-40 | 3.60 | Brij S10 | 8.40 |
| 248 | Compound X TG | 5.50 | Aromatic 200ND Fluid | 79.50 | Crodafos 810A | 4.50 | Brij S10 | 10.50 |
| 249 | Compound X TG | 5.50 | Aromatic 100 Fluid | 76.50 | Phenylsulfonat CAL | 10.80 | Brij L23 | 7.20 |
| 250 | Compound X TG | 5.50 | Aromatic 150 Fluid | 76.50 | BIO-SOFT N-411 | 6.00 | Crovol CR70G | 12.00 |
| 251 | Compound X TG | 5.50 | Aromatic 200ND Fluid | 70.50 | Multiwet 8269 | 7.20 | MAKON 4 | 16.80 |
| 252 | Compound X TG | 5.50 | Aromatic 100 Fluid | 70.50 | Multiwet MO-70R | 11.60 | Emulsogen M | 12.40 |
| 253 | Compound X TG | 5.50 | Aromatic 200 Fluid | 79.50 | Crodasinic SM | 5.25 | MAKON OP-9 | 9.75 |
| 254 | Compound X TG | 5.50 | Aromatic 200ND Fluid | 79.50 | Crodafos CS2A | 9.25 | Emulsogen EL 200 | 5.75 |
| 255 | Compound X TG | 5.50 | Aromatic 150 Fluid | 73.50 | BIO-SOFT D-40 | 9.45 | Synperonic T/905 | 11.55 |
| 256 | Compound X TG | 5.50 | Aromatic 200ND Fluid | 7150 | BIO-SOFT D-40 | 13.65 | Emulsogen TS 290 | 7.35 |
| 257 | Compound X TG | 5.50 | Aromatic 200ND Fluid | 70.50 | Crodafos CO5A | 14.00 | Cithrol 4MS | 10.00 |
| 258 | Compound X TG | 5.50 | Aromatic 200ND Fluid | 82.50 | Phenylsulfonat CA | 7.00 | Synperonic T/908 | 5.00 |
| 259 | Compound X TG | 5.50 | Aromatic 200ND Fluid | 73.50 | Crodafos O3A | 7.70 | Synperonic PE/P 105 | 13.30 |
| 260 | Compound X TG | 5.50 | Aromatic 100 Fluid | 70.50 | Calsogen EH | 10.80 | Synperonic 13/9 | 13.20 |

TABLE 1-14

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 261 | Compound X TG | 5.50 | Aromatic 100 Fluid | 82.50 | Crodafos CO5A | 4.20 | Synperonic T/905 | 7.80 |
| 262 | Compound X TG | 5.50 | Aromatic 200 Fluid | 70.50 | Crodafos CS2A | 14.80 | Brij L4 | 9.20 |
| 263 | Compound X TG | 5.50 | Aromatic 150ND Fluid | 73.50 | Crodafos T5A | 14.35 | Synperonic A3 | 6.65 |
| 264 | Compound X TG | 5.50 | Aromatic 200 Fluid | 82.50 | Crodafos T5A | 5.00 | Sapogenat T 300 | 7.00 |
| 265 | Compound X TG | 5.50 | Aromatic 200 Fluid | 82.50 | Crodafos O3A | 3.60 | Sapogenat T 040 | 8.40 |
| 266 | Compound X TG | 5.50 | Aromatic 100 Fluid | 73.50 | Crodafos T6A | 13.30 | Sapogenat T 130 | 7.70 |
| 267 | Compound X TG | 5.50 | Aromatic 150ND Fluid | 76.50 | Calsogen EH | 9.60 | STEP-FLOW 26 | 8.40 |
| 268 | Compound X TG | 5.50 | Aromatic 200 Fluid | 76.50 | Crodafos CS2A | 8.40 | Sapogenat T 500 | 9.60 |
| 269 | Compound X TG | 5.50 | Aromatic 150 Fluid | 73.50 | SULFONIC 100 | 10.50 | Tween 40 | 10.50 |
| 270 | Compound X TG | 5.50 | Aromatic 100 Fluid | 82.50 | Calsogen AR 100 ND | 4.60 | Crovol PK70 | 7.40 |
| 271 | Compound X TG | 5.50 | Aromatic 150 Fluid | 79.50 | Crodafos T6A | 7.50 | STEP-FLOW 26 | 7.50 |
| 272 | Compound X TG | 5.50 | Aromatic 150 Fluid | 79.50 | Phenylsulfonat CAL | 6.25 | Synperonic T/304 | 8.75 |
| 273 | Compound X TG | 5.50 | Aromatic 200 Fluid | 73.50 | BIO-SOFT N-411 | 13.65 | Atlas G-1086 | 7.35 |
| 274 | Compound X TG | 5.50 | Aromatic 200 Fluid | 82.50 | Crodasinic SM | 6.60 | Synperonic PE/F 68 | 5.40 |
| 275 | Compound X TG | 5.50 | Aromatic 200 Fluid | 70.50 | Crodafos 810A | 10.80 | Synperonic L11 | 13.20 |
| 276 | Compound X TG | 5.50 | Aromatic 100 Fluid | 79.50 | Calsogen 4814 | 4.50 | Brij L4 | 10.50 |
| 277 | Compound X TG | 5.50 | Aromatic 100 Fluid | 79.50 | BIO-SOFT N-411 | 7.25 | Tween 21 | 7.75 |
| 278 | Compound X TG | 5.50 | Aromatic 200ND Fluid | 79.50 | Calsogen AR 100 ND | 4.75 | Cresmer A9 | 10.25 |
| 279 | Compound X TG | 5.50 | Aromatic 150ND Fluid | 79.50 | Calsogen 4814 | 7.25 | TOXIMUL 8323 | 7.75 |
| 280 | Compound X TG | 5.50 | Aromatic 200ND Fluid | 76.50 | Calsogen 4814 | 10.20 | STEP-FLOW LF | 7.80 |

TABLE 1-15

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 281 | Compound X TG | 5.50 | Aromatic 200 Fluid | 70.50 | Crodafos T6A | 15.60 | Myrj S50 | 8.40 |
| 282 | Compound X TG | 5.50 | Aromatic 100 Fluid | 73.50 | Calsogen AR 100 ND | 9.10 | MAKON 4 | 11.90 |
| 283 | Compound X TG | 5.50 | Aromatic 150ND Fluid | 76.50 | BIO-SOFT N-300 | 11.70 | Synperonic 91/10 | 6.30 |
| 284 | Compound X TG | 5.50 | Aromatic 150ND Fluid | 70.50 | BIO-SOFT D-40 | 11.60 | Synperonic PE/F 127 | 12.40 |
| 285 | Compound X TG | 5.50 | Aromatic 100 Fluid | 73.50 | Multiwet MO-70R | 8.05 | Synperonic 13/9 | 12.95 |
| 286 | Compound X TG | 5.50 | Aromatic 100 Fluid | 79.50 | Adinol OT-72 | 8.75 | Synperonic T/908 | 6.25 |
| 287 | Compound X TG | 5.50 | Aromatic 200 Fluid | 70.50 | BIO-SOFT N-411 | 10.00 | Cirrasol G-1096 | 14.00 |
| 288 | Compound X TG | 5.50 | Aromatic 200ND Fluid | 79.50 | BIO-SOFT D-40 | 9.00 | Tween 85 | 6.00 |
| 289 | Compound X TG | 5.50 | Aromatic 150ND Fluid | 73.50 | Multiwet 8269 | 8.05 | Brij L4 | 12.95 |
| 290 | Compound X TG | 5.50 | Aromatic 200 Fluid | 76.50 | BIO-SOFT N-300 | 12.00 | Emulsogen TS 100 | 6.00 |
| 291 | Compound X TG | 5.50 | Aromatic 200ND Fluid | 76.50 | Crodafos CO5A | 11.10 | Cithrol 6MS | 6.90 |
| 292 | Compound X TG | 5.50 | Aromatic 200ND Fluid | 76.50 | Crodasinic O | 6.90 | Synperonic 13/12 | 11.10 |
| 293 | Compound X TG | 5.50 | Aromatic 150ND Fluid | 79.50 | Crodaquat 1207 | 8.25 | Synperonic PE/P 105 | 6.75 |
| 294 | Compound X TG | 5.50 | Aromatic 100 Fluid | 82.50 | Crodafos T6A | 6.00 | Emulsogen M | 6.00 |
| 295 | Compound X TG | 5.50 | Aromatic 200ND Fluid | 82.50 | Phenylsulfonat CAL | 5.40 | Span 20 | 6.60 |
| 296 | Compound X TG | 5.50 | Aromatic 200ND Fluid | 82.50 | BIO-SOFT N-300 | 4.20 | Cirrasol G-1086 | 7.80 |
| 297 | Compound X TG | 5.50 | Aromatic 100 Fluid | 70.50 | Crodafos T5A | 9.20 | Synperonic 91/10 | 14.80 |
| 298 | Compound X TG | 5.50 | Aromatic 200 Fluid | 76.50 | Crodafos CO5A | 7.80 | Tween 60 | 10.20 |
| 299 | Compound X TG | 5.50 | Aromatic 150ND Fluid | 82.50 | SULFONIC 100 | 4.80 | Emulsogen EL 360 | 7.20 |
| 300 | Compound X TG | 5.50 | Aromatic 150 Fluid | 73.50 | BIO-SOFT N-411 | 10.15 | Synperonic 13/10 | 10.85 |

TABLE 1-16

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 301 | Compound X TG | 5.50 | Aromatic 200 Fluid | 73.50 | Phenylsulfonat CAL | 12.25 | Tween 21 | 8.75 |
| 302 | Compound X TG | 5.50 | Aromatic 200 Fluid | 79.50 | Calsogen ARL 100 ND | 7.00 | Synperonic A7 | 8.00 |
| 303 | Compound X TG | 5.50 | Aromatic 150ND Fluid | 76.50 | Phenylsulfonat CA | 6.00 | Tween 20 | 12.00 |
| 304 | Compound X TG | 5.50 | Aromatic 150 Fluid | 82.50 | BIO-TERGE AS-40 | 7.20 | Tween 85 | 4.80 |
| 305 | Compound X TG | 5.50 | Aromatic 200 Fluid | 70.50 | Crodasinic O | 12.00 | Sapogenat T 500 | 12.00 |
| 306 | Compound X TG | 5.50 | Aromatic 150 Fluid | 76.50 | BIO-SOFT D-40 | 6.60 | Synperonic T/905 | 11.40 |
| 307 | Compound X TG | 5.50 | Aromatic 200 Fluid | 70.50 | Crodasinic SM | 13.20 | Brij L23 | 10.80 |
| 308 | Compound X TG | 5.50 | Aromatic 100 Fluid | 73.50 | Phenylsulfonat CA | 7.00 | MAKON 10 | 14.00 |
| 309 | Compound X TG | 5.50 | Aromatic 200 Fluid | 79.50 | Crodafos T5A | 7.00 | Sapogenat T 130 | 8.00 |
| 310 | Compound X TG | 5.50 | Aromatic 200 Fluid | 76.50 | Calsogen ARL 100 ND | 9.60 | Tween 21 | 8.40 |
| 311 | Compound X TG | 5.50 | Aromatic 200ND Fluid | 76.50 | Calsogen ARL 100 ND | 5.70 | Myrj S40 | 12.30 |
| 312 | Compound X TG | 5.50 | Aromatic 100 Fluid | 82.50 | Crodaquat 1207 | 6.40 | MAKON 14 | 5.60 |
| 313 | Compound X TG | 5.50 | Aromatic 100 Fluid | 79.50 | BIO-TERGE AS-40 | 8.00 | Sapogenat T 180 | 7.00 |
| 314 | Compound X TG | 5.50 | Aromatic 200 Fluid | 79.50 | Crodafos CS2A | 4.50 | Cresmer A5 | 10.50 |
| 315 | Compound X TG | 5.50 | Aromatic 150 Fluid | 79.50 | Calsogen ARL 100 ND | 7.75 | Tween 20 | 7.25 |
| 316 | Compound X TG | 5.50 | Aromatic 200ND Fluid | 73.50 | NINATE 411 | 12.60 | Tween 20 | 8.40 |
| 317 | Compound X TG | 5.50 | Aromatic 150ND Fluid | 76.50 | Crodaquat 1207 | 5.40 | Atlas G-1086 | 12.60 |
| 318 | Compound X TG | 5.50 | Aromatic 200ND Fluid | 73.50 | BIO-SOFT D-40 | 12.60 | Tween 85 | 8.40 |
| 319 | Compound X TG | 5.50 | Aromatic 150ND Fluid | 79.50 | Multiwet MO-70R | 8.50 | MAKON 10 | 6.50 |
| 320 | Compound X TG | 5.50 | Aromatic 100 Fluid | 76.50 | Crodafos CO5A | 9.00 | Synperonic 13/9 | 9.00 |

TABLE 1-17

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 321 | Compound X TG | 5.50 | Aromatic 100 Fluid | 76.50 | Crodafos T6A | 11.40 | MAKON 30 | 6.60 |
| 322 | Compound X TG | 5.50 | Aromatic 150 Fluid | 70.50 | Crodaquat TES | 16.40 | Synperonic PE/L 64 | 7.60 |
| 323 | Compound X TG | 5.50 | Aromatic 150 Fluid | 82.50 | BIO-SOFT N-411 | 4.40 | Emulsogen EL 400 | 7.60 |
| 324 | Compound X TG | 5.50 | Aromatic 150 Fluid | 76.50 | Crodaquat 1207 | 12.60 | Synperonic L11 | 5.40 |
| 325 | Compound X TG | 5.50 | Aromatic 150ND Fluid | 70.50 | Crodaquat TES | 7.60 | MAKON 14 | 16.40 |
| 326 | Compound X TG | 5.50 | Aromatic 200 Fluid | 76.50 | Calsogen EH | 7.50 | Crovol A70 | 10.50 |
| 327 | Compound X TG | 5.50 | Aromatic 200ND Fluid | 79.50 | BIO-SOFT N-300 | 10.50 | Emulsogen TS 540 | 4.50 |
| 328 | Compound X TG | 5.50 | Aromatic 150ND Fluid | 70.50 | Calsogen ARL 100 ND | 15.60 | Cresmer A9 | 8.40 |
| 329 | Compound X TG | 5.50 | Aromatic 200 Fluid | 76.50 | BIO-SOFT N-411 | 7.50 | Synperonic PE/F 68 | 10.50 |
| 330 | Compound X TG | 5.50 | Aromatic 100 Fluid | 79.50 | Calsogen EH | 10.00 | Synperonic PE/L 64 | 5.00 |
| 331 | Compound X TG | 5.50 | Aromatic 150 Fluid | 76.50 | Crodafos T6A | 12.00 | MAKON 4 | 6.00 |
| 332 | Compound X TG | 5.50 | Aromatic 150 Fluid | 70.50 | Crodafos O3A | 8.40 | Myrj 58 | 15.60 |
| 333 | Compound X TG | 5.50 | Aromatic 150ND Fluid | 73.50 | Calsogen AR 100 ND | 9.45 | Synperonic A20 | 11.55 |
| 334 | Compound X TG | 5.50 | Aromatic 200ND Fluid | 79.50 | Crodasinic O | 9.00 | Cithrol 10MS | 6.00 |
| 335 | Compound X TG | 5.50 | Aromatic 200 Fluid | 73.50 | Crodaquat 1207 | 9.45 | STEP-FLOW 26 | 11.55 |
| 336 | Compound X TG | 5.50 | Aromatic 150ND Fluid | 79.50 | Multiwet 8269 | 5.25 | Span 20 | 9.75 |
| 337 | Compound X TG | 5.50 | Aromatic 150 Fluid | 70.50 | BIO-TERGE AS-40 | 10.00 | Cirrasol G-1086 | 14.00 |
| 338 | Compound X TG | 5.50 | Aromatic 200ND Fluid | 70.50 | BIO-SOFT D-40 | 13.20 | Synperonic PE/F 68 | 10.80 |
| 339 | Compound X TG | 5.50 | Aromatic 150 Fluid | 79.50 | Phenylsulfonat CAL | 9.00 | TOXIMUL 8321 | 6.00 |
| 340 | Compound X TG | 5.50 | Aromatic 100 Fluid | 79.50 | Calsogen 4814 | 9.50 | Crovol A70 | 5.50 |

TABLE 1-18

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 341 | Compound X TG | 5.50 | Aromatic 100 Fluid | 70.50 | Calsogen EH | 7.60 | Solan 75 | 16.40 |
| 342 | Compound X TG | 5.50 | Aromatic 100 Fluid | 76.50 | Multiwet 8269 | 9.90 | Solan 75 | 8.10 |
| 343 | Compound X TG | 5.50 | Aromatic 100 Fluid | 73.50 | Crodafos O3A | 6.65 | Emulsogen EL 300 LM | 14.35 |
| 344 | Compound X TG | 5.50 | Aromatic 150 Fluid | 70.50 | BIO-SOFT N-300 | 16.80 | Synperonic A4 | 7.20 |
| 345 | Compound X TG | 5.50 | Aromatic 200 Fluid | 70.50 | Crodaquat 1207 | 12.00 | Tween 85 | 12.00 |
| 346 | Compound X TG | 5.50 | Aromatic 200ND Fluid | 70.50 | Crodafos 810A | 9.20 | Synperonic A3 | 14.80 |
| 347 | Compound X TG | 5.50 | Aromatic 100 Fluid | 76.50 | Crodaquat 1207 | 6.30 | Atlox 1045A | 11.70 |
| 348 | Compound X TG | 5.50 | Aromatic 150ND Fluid | 76.50 | Crodafos T5A | 5.70 | Synperonic A20 | 12.30 |
| 349 | Compound X TG | 5.50 | Aromatic 200ND Fluid | 79.50 | Phenylsulfonat CA | 5.75 | Cithrol 4MS | 9.25 |
| 350 | Compound X TG | 5.50 | Aromatic 150 Fluid | 73.50 | Crodasinic O | 7.35 | Emulsogen M | 13.65 |
| 351 | Compound X TG | 5.50 | Aromatic 200 Fluid | 70.50 | Crodaquat TES | 12.00 | Myrj S100 | 12.00 |
| 352 | Compound X TG | 5.50 | Aromatic 200ND Fluid | 70.50 | Adinol OT-72 | 8.00 | Emulsogen EL 200 | 16.00 |
| 353 | Compound X TG | 5.50 | Aromatic 150ND Fluid | 82.50 | Crodasinic O | 7.40 | Synperonic 13/10 | 4.60 |
| 354 | Compound X TG | 5.50 | Aromatic 100 Fluid | 82.50 | Multiwet 8269 | 5.80 | TOXIMUL 8321 | 6.20 |
| 355 | Compound X TG | 5.50 | Aromatic 150ND Fluid | 82.50 | Crodaquat 1207 | 7.20 | Cirrasol G-1096 | 4.80 |
| 356 | Compound X TG | 5.50 | Aromatic 150ND Fluid | 79.50 | NINATE 411 | 6.25 | Synperonic A3 | 8.75 |
| 357 | Compound X TG | 5.50 | Aromatic 200ND Fluid | 70.50 | Calsogen AR 100 ND | 13.20 | Emulsogen TS 200 | 10.80 |
| 358 | Compound X TG | 5.50 | Aromatic 150 Fluid | 76.50 | Crodafos CS2A | 7.20 | Cresmer A20 | 10.80 |
| 359 | Compound X TG | 5.50 | Aromatic 100 Fluid | 79.50 | Crodasinic O | 10.00 | MAKON 30 | 5.00 |
| 360 | Compound X TG | 5.50 | Aromatic 100 Fluid | 79.50 | Calsogen AR 100 ND | 7.75 | MAKON 14 | 7.25 |

TABLE 1-19

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 361 | Compound X TG | 5.50 | Aromatic 200ND Fluid | 79.50 | NINATE 411 | 9.25 | Emulsogen EL 540 | 5.75 |
| 362 | Compound X TG | 5.50 | Aromatic 100 Fluid | 70.50 | Crodasinic O | 7.20 | Tween 80 | 16.80 |
| 363 | Compound X TG | 5.50 | Aromatic 200 Fluid | 73.50 | Crodaquat TES | 10.85 | Sapogenat T 060 | 10.15 |
| 364 | Compound X TG | 5.50 | Aromatic 150ND Fluid | 82.50 | NINATE 411 | 6.60 | Synperonic A20 | 5.40 |
| 365 | Compound X TG | 5.50 | Aromatic 150 Fluid | 79.50 | Calsogen EH | 6.00 | Arlatone TV | 9.00 |
| 366 | Compound X TG | 5.50 | Aromatic 200 Fluid | 70.50 | Crodafos 810A | 14.40 | Emulsogen EL 540 | 9.60 |
| 367 | Compound X TG | 5.50 | Aromatic 200 Fluid | 73.50 | SULFONIC 100 | 6.30 | Myrj S50 | 14.70 |
| 368 | Compound X TG | 5.50 | Aromatic 200ND Fluid | 73.50 | Crodafos T5A | 9.10 | Cresmer A11 | 11.90 |
| 369 | Compound X TG | 5.50 | Aromatic 200ND Fluid | 76.50 | Crodaquat 1207 | 12.60 | Brij C10 | 5.40 |
| 370 | Compound X TG | 5.50 | Aromatic 150ND Fluid | 73.50 | NINATE 411 | 13.30 | Cithrol 10MS | 7.70 |
| 371 | Compound X TG | 5.50 | Aromatic 200 Fluid | 73.50 | Crodafos 810A | 11.20 | Sapogenat T 040 | 9.80 |
| 372 | Compound X TG | 5.50 | Aromatic 100 Fluid | 70.50 | Crodaquat 1207 | 10.00 | Tween 60 | 14.00 |
| 373 | Compound X TG | 5.50 | Aromatic 200ND Fluid | 79.50 | Calsogen EH | 7.75 | Sapogenat T 300 | 7.25 |
| 374 | Compound X TG | 5.50 | Aromatic 150ND Fluid | 73.50 | Crodafos CO5A | 8.05 | Synperonic A7 | 12.95 |
| 375 | Compound X TG | 5.50 | Aromatic 200ND Fluid | 82.50 | Crodaquat TES | 4.00 | Brij S721 | 8.00 |
| 376 | Compound X TG | 5.50 | Aromatic 150ND Fluid | 76.50 | Adinol OT-72 | 11.10 | Tween 40 | 6.90 |
| 377 | Compound X TG | 5.50 | Aromatic 150ND Fluid | 73.50 | Phenylsulfonat CAL | 7.35 | Synperonic PE/F 127 | 13.65 |
| 378 | Compound X TG | 5.50 | Aromatic 150 Fluid | 82.50 | Calsogen EH | 5.80 | Synperonic PE/F 127 | 6.20 |
| 379 | Compound X TG | 5.50 | Aromatic 200ND Fluid | 82.50 | Adinol OT-72 | 3.60 | Crovol A70 | 8.40 |
| 380 | Compound X TG | 5.50 | Aromatic 150 Fluid | 73.50 | Multiwet MO-70R | 8.75 | Tween 61 | 12.25 |

TABLE 1-20

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 381 | Compound X TG | 5.50 | Aromatic 100 Fluid | 82.50 | Calsogen AR 100 ND | 4.00 | MAKON 6 | 8.00 |
| 382 | Compound X TG | 5.50 | Aromatic 150 Fluid | 70.50 | Crodafos T5A | 9.60 | Emulsogen TS 540 | 14.40 |
| 383 | Compound X TG | 5.50 | Aromatic 150ND Fluid | 70.50 | SULFONIC 100 | 7.20 | Tween 81 | 16.80 |
| 384 | Compound X TG | 5.50 | Aromatic 150 Fluid | 70.50 | Phenylsulfonat CAL | 15.20 | STEP-FLOW 26 | 8.80 |
| 385 | Compound X TG | 5.50 | Aromatic 100 Fluid | 82.50 | BIO-SOFT D-40 | 7.00 | Emulsogen TS 540 | 5.00 |
| 386 | Compound X TG | 5.50 | Aromatic 100 Fluid | 82.50 | Calsogen AR 100 ND | 6.20 | Crovol M70 | 5.80 |
| 387 | Compound X TG | 5.50 | Aromatic 200 Fluid | 70.50 | Crodasinic SM | 13.20 | Solan 60 | 10.80 |
| 388 | Compound X TG | 5.50 | Aromatic 100 Fluid | 70.50 | Crodafos T6A | 9.20 | Synperonic PE/P 84 | 14.80 |
| 389 | Compound X TG | 5.50 | Aromatic 200 Fluid | 76.50 | Calsogen 4814 | 10.80 | Synperonic PE/P 105 | 7.20 |
| 390 | Compound X TG | 5.50 | Aromatic 100 Fluid | 79.50 | Crodafos 810A | 5.25 | Crovol PK70 | 9.75 |
| 391 | Compound X TG | 5.50 | Aromatic 200 Fluid | 73.50 | BIO-SOFT N-300 | 8.40 | Emulsogen EL 400 | 12.60 |
| 392 | Compound X TG | 5.50 | Aromatic 100 Fluid | 73.50 | Crodafos 810A | 9.45 | Atlox 1045A | 11.55 |
| 393 | Compound X TG | 5.50 | Aromatic 100 Fluid | 73.50 | Crodafos O3A | 7.35 | Synperonic 13/12 | 13.65 |
| 394 | Compound X TG | 5.50 | Aromatic 150 Fluid | 82.50 | Multiwet MO-70R | 7.80 | Synperonic PE/F 108 | 4.20 |
| 395 | Compound X TG | 5.50 | Aromatic 150ND Fluid | 82.50 | Multiwet 8269 | 8.40 | Cresmer A9 | 3.60 |
| 396 | Compound X TG | 5.50 | Aromatic 150ND Fluid | 82.50 | Phenylsulfonat CAL | 6.00 | Cithrol 6MS | 6.00 |
| 397 | Compound X TG | 5.50 | Aromatic 150 Fluid | 73.50 | Phenylsulfonat CAL | 13.65 | Crovol M70 | 7.35 |
| 398 | Compound X TG | 5.50 | Aromatic 200ND Fluid | 73.50 | Crodafos T6A | 6.30 | Synperonic PE/F 108 | 14.70 |
| 399 | Compound X TG | 5.50 | Aromatic 150 Fluid | 76.50 | NINATE 411 | 8.10 | Tween 81 | 9.90 |
| 400 | Compound X TG | 5.50 | Aromatic 200ND Fluid | 70.50 | Crodaquat 1207 | 10.80 | Synperonic PE/L 44 | 13.20 |

TABLE 1-21

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 401 | Compound X TG | 5.50 | Aromatic 100 Fluid | 82.50 | Calsogen EH | 6.20 | Sapogenat T 180 | 5.80 |
| 402 | Compound X TG | 5.50 | Aromatic 150ND Fluid | 73.50 | Crodaquat TES | 14.35 | MAKON 30 | 6.65 |
| 403 | Compound X TG | 5.50 | Aromatic 100 Fluid | 76.50 | Crodafos CS2A | 12.30 | Synperonic 13/8 | 5.70 |
| 404 | Compound X TG | 5.50 | Aromatic 200 Fluid | 73.50 | Crodasinic SM | 8.75 | Emulsogen EL 360 | 12.25 |
| 405 | Compound X TG | 5.50 | Aromatic 200 Fluid | 79.50 | Crodaquat TES | 10.50 | MAKON 8 | 4.50 |
| 406 | Compound X TG | 5.50 | Aromatic 200 Fluid | 70.50 | Multiwet 8269 | 7.20 | MAKON OP-9 | 16.80 |
| 407 | Compound X TG | 5.50 | Aromatic 200ND Fluid | 82.50 | Crodafos T5A | 8.40 | Emulsogen EL 300 LM | 3.60 |
| 408 | Compound X TG | 5.50 | Aromatic 150 Fluid | 73.50 | Crodasinic SM | 11.55 | TOXIMUL 8321 | 9.45 |
| 409 | Compound X TG | 5.50 | Aromatic 100 Fluid | 70.50 | Crodaquat TES | 8.00 | Cithrol 6MS | 16.00 |
| 410 | Compound X TG | 5.50 | Aromatic 150 Fluid | 79.50 | BIO-TERGE AS-40 | 5.75 | Synperonic PE/L 44 | 9.25 |
| 411 | Compound X TG | 5.50 | Aromatic 100 Fluid | 70.50 | BIO-SOFT D-40 | 16.00 | Cithrol 10MS | 8.00 |
| 412 | Compound X TG | 5.50 | Aromatic 100 Fluid | 76.50 | Multiwet MO-70R | 7.20 | Cithrol 10MS | 10.80 |
| 413 | Compound X TG | 5.50 | Aromatic 200ND Fluid | 73.50 | Calsogen 4814 | 14.00 | Emulsogen TS 540 | 7.00 |
| 414 | Compound X TG | 5.50 | Aromatic 100 Fluid | 73.50 | Calsogen AR 100 ND | 11.20 | Synperonic PE/F 87 | 9.80 |
| 415 | Compound X TG | 5.50 | Aromatic 150 Fluid | 79.50 | BIO-SOFT N-300 | 7.50 | Cresmer A11 | 7.50 |
| 416 | Compound X TG | 5.50 | Aromatic 200 Fluid | 79.50 | Crodasinic SM | 5.00 | Myrj S20 | 10.00 |
| 417 | Compound X TG | 5.50 | Aromatic 200ND Fluid | 73.50 | Crodasinic O | 14.70 | Synperonic PE/F 68 | 6.30 |
| 418 | Compound X TG | 5.50 | Aromatic 150ND Fluid | 79.50 | Crodafos CO5A | 7.75 | Cithrol 6MS | 7.25 |
| 419 | Compound X TG | 5.50 | Aromatic 200ND Fluid | 73.50 | BIO-SOFT N-411 | 7.70 | Cithrol 4ML | 13.30 |
| 420 | Compound X TG | 5.50 | Aromatic 100 Fluid | 76.50 | Calsogen 4814 | 11.40 | Myrj S100 | 6.60 |

TABLE 1-22

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 421 | Compound X TG | 5.50 | Aromatic 150 Fluid | 82.50 | Crodasinic SM | 4.40 | TOXIMUL 8323 | 7.60 |
| 422 | Compound X TG | 5.50 | Aromatic 150 Fluid | 79.50 | Crodafos CO5A | 4.75 | STEP-FLOW LF | 10.25 |
| 423 | Compound X TG | 5.50 | Aromatic 150ND Fluid | 79.50 | Crodafos CS2A | 5.50 | Solan 60 | 9.50 |
| 424 | Compound X TG | 5.50 | Aromatic 150ND Fluid | 73.50 | Crodafos CS2A | 8.75 | Myrj S8 | 12.25 |
| 425 | Compound X TG | 5.50 | Aromatic 200 Fluid | 73.50 | Calsogen ARL 100 ND | 10.85 | STEP-FLOW LF | 10.15 |
| 426 | Compound X TG | 5.50 | Aromatic 150 Fluid | 73.50 | Crodafos CO5A | 14.00 | Atlas G-1096 | 7.00 |
| 427 | Compound X TG | 5.50 | Aromatic 200 Fluid | 70.50 | Crodafos CS2A | 13.60 | MAKON 30 | 10.40 |
| 428 | Compound X TG | 5.50 | Aromatic 100 Fluid | 82.50 | Crodasinic SM | 6.80 | MAKON 30 | 5.20 |
| 429 | Compound X TG | 5.50 | Aromatic 200ND Fluid | 76.50 | Multiwet MO-70R | 5.40 | Cithrol 4ML | 12.60 |
| 430 | Compound X TG | 5.50 | Aromatic 150ND Fluid | 79.50 | BIO-SOFT N-411 | 9.50 | Brij O10 | 5.50 |
| 431 | Compound X TG | 5.50 | Aromatic 100 Fluid | 76.50 | Crodasinic SM | 6.60 | Synperonic A3 | 11.40 |
| 432 | Compound X TG | 5.50 | Aromatic 200ND Fluid | 70.50 | Calsogen AR 100 ND | 8.00 | Brij S10 | 16.00 |
| 433 | Compound X TG | 5.50 | Aromatic 200ND Fluid | 73.50 | Crodafos CS2A | 10.85 | Solan 75 | 10.15 |
| 434 | Compound X TG | 5.50 | Aromatic 150 Fluid | 82.50 | Crodafos O3A | 3.60 | Myrj S40 | 8.40 |
| 435 | Compound X TG | 5.50 | Aromatic 150 Fluid | 79.50 | Adinol OT-72 | 8.00 | MAKON 4 | 7.00 |
| 436 | Compound X TG | 5.50 | Aromatic 200 Fluid | 70.50 | Crodafos CS2A | 12.40 | Atlas G-1086 | 11.60 |
| 437 | Compound X TG | 5.50 | Aromatic 150 Fluid | 82.50 | Crodafos 810A | 7.40 | Synperonic T/304 | 4.60 |
| 438 | Compound X TG | 5.50 | Aromatic 150 Fluid | 70.50 | Phenylsulfonat CA | 12.40 | Sapogenat T 060 | 11.60 |
| 439 | Compound X TG | 5.50 | Aromatic 150 Fluid | 70.50 | SULFONIC 100 | 13.60 | Tween 20 | 10.40 |
| 440 | Compound X TG | 5.50 | Aromatic 200 Fluid | 73.50 | Calsogen EH | 11.90 | Arlatone TV | 9.10 |

TABLE 1-23

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 441 | Compound X TG | 5.50 | Aromatic 150ND Fluid | 82.50 | Phenylsulfonat CA | 7.80 | Atlox 1045A | 4.20 |
| 442 | Compound X TG | 5.50 | Aromatic 200ND Fluid | 73.50 | Crodasinic O | 7.70 | Synperonic 91/10 | 13.30 |
| 443 | Compound X TG | 5.50 | Aromatic 150ND Fluid | 70.50 | Multiwet MO-70R | 12.40 | Tween 21 | 11.60 |
| 444 | Compound X TG | 5.50 | Aromatic 200 Fluid | 82.50 | Adinol OT-72 | 5.60 | Tween 21 | 6.40 |
| 445 | Compound X TG | 5.50 | Aromatic 100 Fluid | 82.50 | Calsogen ARL 100 ND | 5.20 | Synperonic PE/P 105 | 6.80 |
| 446 | Compound X TG | 5.50 | Aromatic 150 Fluid | 76.50 | Multiwet 8269 | 5.40 | Emulsogen TS 600 | 12.60 |
| 447 | Compound X TG | 5.50 | Aromatic 150 Fluid | 73.50 | Crodafos 810A | 10.15 | Myrj S40 | 10.85 |
| 448 | Compound X TG | 5.50 | Aromatic 150ND Fluid | 70.50 | SULFONIC 100 | 16.40 | Tween 65 | 7.60 |
| 449 | Compound X TG | 5.50 | Aromatic 100 Fluid | 82.50 | BIO-SOFT N-300 | 5.40 | Tween 81 | 6.60 |
| 450 | Compound X TG | 5.50 | Aromatic 100 Fluid | 79.50 | Calsogen ARL 100 ND | 10.00 | Cirrasol G-1096 | 5.00 |
| 451 | Compound X TG | 5.50 | Aromatic 200ND Fluid | 76.50 | Phenylsulfonat CA | 11.70 | MAKON OP-9 | 6.30 |
| 452 | Compound X TG | 5.50 | Aromatic 100 Fluid | 70.50 | Phenylsulfonat CAL | 8.00 | Synperonic 13/12 | 16.00 |
| 453 | Compound X TG | 5.50 | Aromatic 150ND Fluid | 79.50 | Crodasinic O | 8.25 | TOXIMUL L-62 | 6.75 |
| 454 | Compound X TG | 5.50 | Aromatic 150 Fluid | 73.50 | Calsogen 4814 | 14.35 | Cirrasol G-1096 | 6.65 |
| 455 | Compound X TG | 5.50 | Aromatic 200ND Fluid | 70.50 | Adinol OT-72 | 13.60 | TOXIMUL L-62 | 10.40 |
| 456 | Compound X TG | 5.50 | Aromatic 200ND Fluid | 82.50 | Calsogen EH | 4.60 | Synperonic A4 | 7.40 |
| 457 | Compound X TG | 5.50 | Aromatic 150 Fluid | 82.50 | BIO-SOFT D-40 | 5.40 | Emulsogen EL 200 | 6.60 |
| 458 | Compound X TG | 5.50 | Aromatic 200ND Fluid | 82.50 | Crodaquat 1207 | 3.80 | Synperonic A7 | 8.20 |
| 459 | Compound X TG | 5.50 | Aromatic 200ND Fluid | 76.50 | Crodafos 810A | 5.70 | Brij C20 | 12.30 |
| 460 | Compound X TG | 5.50 | Aromatic 100 Fluid | 70.50 | Multiwet 8269 | 16.80 | Synperonic 13/8 | 7.20 |

TABLE 1-24

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 461 | Compound X TG | 5.50 | Aromatic 200 Fluid | 73.50 | BIO-TERGE AS-40 | 12.95 | Synperonic PE/L 44 | 8.05 |
| 462 | Compound X TG | 5.50 | Aromatic 150ND Fluid | 82.50 | Multiwet MO-70R | 4.60 | Myrj S100 | 7.40 |
| 463 | Compound X TG | 5.50 | Aromatic 150ND Fluid | 76.50 | BIO-SOFT D-40 | 8.70 | MAKON 14 | 9.30 |
| 464 | Compound X TG | 5.50 | Aromatic 150ND Fluid | 76.50 | SULFONIC 100 | 6.90 | Synperonic PE/L 44 | 11.10 |
| 465 | Compound X TG | 5.50 | Aromatic 150ND Fluid | 76.50 | Multiwet MO-70R | 9.60 | Tween 61 | 8.40 |
| 466 | Compound X TG | 5.50 | Aromatic 150ND Fluid | 79.50 | Crodafos T6A | 6.75 | Synperonic PE/F 108 | 8.25 |
| 467 | Compound X TG | 5.50 | Aromatic 200 Fluid | 82.50 | Crodafos T5A | 6.40 | Brij O10 | 5.60 |
| 468 | Compound X TG | 5.50 | Aromatic 100 Fluid | 79.50 | SULFONIC 100 | 8.25 | Emulsogen TS 100 | 6.75 |
| 469 | Compound X TG | 5.50 | Aromatic 200 Fluid | 82.50 | Crodafos 810A | 6.60 | Synperonic 13/9 | 5.40 |
| 470 | Compound X TG | 5.50 | Aromatic 150ND Fluid | 79.50 | Calsogen AR 100 ND | 5.00 | Brij O20 | 10.00 |
| 471 | Compound X TG | 5.50 | Aromatic 150 Fluid | 70.50 | NINATE 411 | 12.00 | Crovol A70 | 12.00 |
| 472 | Compound X TG | 5.50 | Aromatic 150 Fluid | 82.50 | Crodafos 810A | 5.80 | Synperonic PE/L 44 | 6.20 |
| 473 | Compound X TG | 5.50 | Aromatic 150 Fluid | 76.50 | Crodafos 810A | 9.00 | Sapogenat T 300 | 9.00 |
| 474 | Compound X TG | 5.50 | Aromatic 100 Fluid | 70.50 | Crodafos CO5A | 14.00 | Brij C10 | 10.00 |
| 475 | Compound X TG | 5.50 | Aromatic 200ND Fluid | 82.50 | BIO-SOFT N-300 | 6.00 | Brij S20 | 6.00 |
| 476 | Compound X TG | 5.50 | Aromatic 150ND Fluid | 70.50 | Crodasinic SM | 13.60 | MAKON 6 | 10.40 |
| 477 | Compound X TG | 5.50 | Aromatic 100 Fluid | 73.50 | BIO-TERGE AS-40 | 12.25 | Brij C20 | 8.75 |
| 478 | Compound X TG | 5.50 | Aromatic 150 Fluid | 73.50 | Calsogen EH | 11.90 | Span 20 | 9.10 |
| 479 | Compound X TG | 5.50 | Aromatic 200 Fluid | 82.50 | Multiwet 8269 | 3.80 | Emulsogen TS 100 | 8.20 |
| 480 | Compound X TG | 5.50 | Aromatic 150ND Fluid | 73.50 | Crodaquat 1207 | 6.30 | Crovol A70 | 14.70 |

TABLE 1-25

| Production | Pesticidal active | Mass ratio | Water-immiscible | Mass ratio | Ionic | Mass ratio | Nonionic | Mass ratio |
|---|---|---|---|---|---|---|---|---|
| Example | ingredient | (w/w %) | solvent | (w/w %) | surfactant | (w/w %) | surfactant | (w/w %) |
| 481 | Compound X TG | 5.50 | Aromatic 150 Fluid | 82.50 | BIO-TERGE AS-40 | 7.60 | Emulsogen TS 290 | 4.40 |
| 482 | Compound X TG | 5.50 | Aromatic 150 Fluid | 79.50 | Crodaquat TES | 9.25 | Synperonic A20 | 5.75 |
| 483 | Compound X TG | 5.50 | Aromatic 200ND Fluid | 70.50 | BIO-SOFT D-40 | 16.40 | MAKON 10 | 7.60 |
| 484 | Compound X TG | 5.50 | Aromatic 150ND Fluid | 73.50 | Crodafos O3A | 13.65 | MAKON 14 | 7.35 |
| 485 | Compound X TG | 5.50 | Aromatic 150 Fluid | 76.50 | Phenylsulfonat CA | 8.40 | Cresmer A11 | 9.60 |
| 486 | Compound X TG | 5.50 | Aromatic 100 Fluid | 76.50 | Crodafos CO5A | 10.50 | Myrj S20 | 7.50 |
| 487 | Compound X TG | 5.50 | Aromatic 150 Fluid | 82.50 | Calsogen ARL 100 ND | 4.00 | Sapogenat T 110 | 8.00 |
| 488 | Compound X TG | 5.50 | Aromatic 150 Fluid | 73.50 | Phenylsulfonat CA | 8.05 | Brij C10 | 12.95 |
| 489 | Compound X TG | 5.50 | Aromatic 150 Fluid | 73.50 | Calsogen ARL 100 ND | 6.65 | Synperonic 13/8 | 14.35 |
| 490 | Compound X TG | 5.50 | Aromatic 200 Fluid | 76.50 | Phenylsulfonat CAL | 8.70 | Brij S20 | 9.30 |
| 491 | Compound X TG | 5.50 | Aromatic 100 Fluid | 79.50 | Crodafos 15A | 5.75 | Solan 75 | 9.25 |
| 492 | Compound X TG | 5.50 | Aromatic 150 Fluid | 76.50 | Calsogen ARL 100 ND | 7.50 | MAKON 10 | 10.50 |
| 493 | Compound X TG | 5.50 | Aromatic 150ND Fluid | 79.50 | NINATE 411 | 6.50 | Synperonic PE/F 127 | 8.50 |
| 494 | Compound X TG | 5.50 | Aromatic 150 Fluid | 73.50 | Adinol OT-72 | 9.80 | Cithrol 6MS | 11.20 |
| 495 | Compound X TG | 5.50 | Aromatic 150 Fluid | 76.50 | NINATE 411 | 11.40 | Synperonic PE/P 84 | 6.60 |
| 496 | Compound X TG | 5.50 | Aromatic 100 Fluid | 76.50 | Crodafos CS2A | 7.80 | Sapogenat T 130 | 10.20 |
| 497 | Compound X TG | 5.50 | Aromatic 200 Fluid | 76.50 | Phenylsulfonat CAL | 8.70 | Brij O10 | 9.30 |
| 498 | Compound X TG | 5.50 | Aromatic 150 Fluid | 76.50 | Crodafos O3A | 9.90 | Synperonic 13/10 | 8.10 |
| 499 | Compound X TG | 5.50 | Aromatic 150 Fluid | 79.50 | Adinol OT-72 | 5.50 | Synperonic PE/F 87 | 9.50 |
| 500 | Compound X TG | 5.50 | Aromatic 200 Fluid | 76.50 | Calsogen AR 100 ND | 9.90 | Span 20 | 8.10 |

Table 2-1 and Table 2-4 show details of the ingredients specified in Table 1-1 to Table 1-25.

TABLE 2-1

| Trade name | Principal ingredient | Supplyer |
|---|---|---|
| Aromatic 100 Fluid | Solvent naphtha (petroleum), light aromatic, containing C9-C10 dialkyl- and | Exxon |
| | trialkylbenzene as its main aromatic hydrocarbon | |
| Aromatic 150 Fluid | Solvent naphtha (petroleum), heavy aromatic, containing C10-C11 alkyl | Exxon |
| | benzene as its main aromatic hydrocarbon | |
| Aromatic 150ND Fluid | Solvent naphtha (petroleum), heavy aromatic, containing C10-C11 alkyl | Exxon |
| | benzene as its main aromatic hydrocarbon | |
| Aromatic 200 Fluid | Solvent naphtha (petroleum), heavy aromatic, containing C10-C13 alkyl | Exxon |
| | naphthalene as its main aromatic hydrocarbon | |
| Aromatic 200ND Fluid | Solvent naphtha (petroleum), heavy aromatic, containing C10-C13 alkyl | Exxon |
| | naphthalene as its main aromatic hydrocarbon | |
| Calsogen 4814 | n-C12 alkyl benzene sulfonate calcium salt (active content: 58% (in | Clariant |
| | 2-ethylhexanol)) | |
| Calsogen AR 100 ND | iso-C12 alkyl benzene sulfonate calcium salt (active content: 40% + 10% (in | Clariant |
| | Aromatic 200ND Fluid)) | |
| Calsogen ARL 100 ND | n-C12 alkyl benzene sulfonate calcium salt (active content: 40% + 10% (in | Clariant |
| | Aromatic 200ND Fluid)) | |
| Calsogen EH | iso-C12 alkyl benzene sulfonate calcium salt (active content: 58% (in | Clariant |
| | 2-ethylhexanol)) | |
| Phenylsulfonat CA | iso-C12 alkyl benzene sulfonate calcium salt (active content: 70% (in | Clariant |
| | iso-butanol)) | |
| Phenylsulfonat CAL | n-C12 alkyl benzene sulfonate calcium salt (active content: 70% (in | Clariant |
| | iso-butanol)) | |
| NINATE 411 | Isopropylamine dodecylbenzene sulfonate, branched (active content: 88%) | Stepan |
| BIO-SOFT N-411 | lsopropylamine dodecylbenzene sulfonate, linear (active content: 90%) | Stepan |
| BIO-SOFT D-40 | Sodium dodecylbenzene sulfonate, linear (active content: 40%) | Stepan |
| BIO-SOFT N-300 | TEA-dodecylbenzene sulfonate (active content; 60%) | Stepan |
| SULFONIC 100 | Dodecylbenzene sulfonic acid, branched (active content: 95%) | Stepan |
| BIO-TERGE AS-40 | Sodium C14-16 olefin sulfonate (active content: 39%) | Stepan |
| Crodafos 810A | C8-C10 acid phosphate | CRODA |
| Crodafos CO5A | Polyoxyethylene (5EO) cetyl-oleyl mono/di-phosphate | CRODA |
| Crodafos CS2A | Polyoxyethylene (2EO) cetyl-stearyl mono/di-phosphate | CRODA |
| Crodafos O3A | Polyoxyethylene (3EO) oleyl mono/di-phosphate | CRODA |
| Crodafos T5A | Polyoxyethylene (5EO) tridecyl mono/di-phosphate | CRODA |
| Crodafos T6A | Polyoxyethylene branched tridecyl phosphate | CRODA |
| Adinol OT-72 | Sodium N-methyl oleoyl taurate | CRODA |
| Crodasinic O | Oleoyl sarcosine | CRODA |
| Crodasinic SM | Stearoyl/myristoyl sarcosine | CRODA |
| Multiwet MO-70R | Sodium dioctyl sulfosuccinate | CRODA |
| Multiwet 8269 | Dioctyl sodium sulfosuccinate | CRODA |
| Crodaquat 1207 | Polyoxyethylene alkylamine quaternary | CRODA |
| Crodaquat TES | Polyoxyethylene tallow ethylmonium ethosulfate | CRODA |

TABLE 2-2

| Trade name | Principal ingredient | Supplyer |
|---|---|---|
| Emulsogen TS 100 | 2,4,6-Tri(1-phenylethyl)-phenol polyglycol ether with 10 EO | Clariant |
| Emulsogen TS 160 | 2,4,6-Tri(1-phenylethyl)-phenol polyglycol ether with 16 EO | Clariant |
| Emulsogen TS 200 | 2,4,6-Tri(1-phenylethyl)-phenol polyglycol ether with 20 EO | Clariant |
| Emulsogen TS 290 | 2,4,6-Tri(1-phenylethyl)-phenol polyglycol ether with 29 EO | Clariant |
| Emulsogen TS 540 | 2,4,6-Tri(1-phenylethyl)-phenol polyglycol ether with 54 EO | Clariant |
| Emulsogen TS 600 | 2,4,6-Tri(1-phenylethyl)-phenol polyglycol ether with 60 EO | Clariant |
| Sapogenat T 040 | Tri-sec-butylphenol polyglycol ether with 4 EO | Clariant |
| Sapogenat T 060 | Tri-sec-butylphenol polyglycol ether with 6 EO | Clariant |
| Sapogenat T 080 | Tri-sec-butylphenol polyglycol ether with 8 EO | Clariant |
| Sapogenat T 110 | Tri-sec-butylphenol polyglycol ether with 11 EO | Clariant |
| Sapogenat T 130 | Tri-sec-butylphenol polyglycol ether with 13 EO | Clariant |
| Sapogenat T 180 | Tri-sec-butylphenol polyglycol ether with 18 EO | Clariant |
| Sapogenat T 300 | Tri-sec-butylphenol polyglycol ether with 30 EO | Clariant |
| Sapogenat T 500 | Tri-sec-butylphenol polyglycol ether with 50 EO | Clariant |
| MAKON 4 | Nonylphenol ethoxylate, POE-4 | Stepan |
| MAKON 6 | Nonylphenol ethoxylate, POE-6 | Stepan |
| MAKON 8 | Nonylphenol ethoxylate, POE-8 | Stepan |
| MAKON 10 | Nonylphenol ethoxylate, POE-10 | Stepan |
| MAKON 12 | Nonylphenol ethoxylate, POE-12 | Stepan |
| MAKON 14 | Nonylphenol ethoxylate, POE-14 | Stepan |
| MAKON 30 | Nonylphenol ethoxylate, POE-30 | Stepan |
| MAKON OP-9 | Octylphenol ethoxylate, POE-9 | Stepan |
| Brij C10 | Polyoxyethylene (10EO) cetyl ether | CRODA |
| Brij C20 | Polyoxyethylene (20EO) cetyl ether | CRODA |
| Brij L4 | Polyoxyethylene (4EO) lauryl ether | CRODA |
| Brij L23 | Polyoxyethylene (23EO) lauryl ether | CRODA |
| Brij O10 | Polyoxyethylene (10EO) oleyl ether | CRODA |
| Brij O20 | Polyoxyethylene (20EO) oleyl ether | CRODA |
| Brij S10 | Polyoxyethylene (10EO) stearyl ether | CRODA |
| Brij S20 | Polyoxyethylene (20EO) stearyl ether | CRODA |
| Brij S100 | Polyoxyethylene (100EO) stearyl ether | CRODA |
| Brij S721 | Polyoxyethylene (21EO) stearyl ether | CRODA |
| Synperonic L11 | Polyoxyethylene (11EO) lauryl ether | CRODA |
| Cresmer AS | Polyoxyethylene (5EO) C12-C15 alcohol | CRODA |
| Cresmer A9 | Polyoxyethylene (9EO) C12-C15 alcohol | CRODA |

TABLE 2-3

| Trade name | Principal ingredient | Supplyer |
|---|---|---|
| Cresmer A11 | Polyoxyethylene (11EO) C12-C15 alcohol | CRODA |
| Cresmer A20 | Polyoxyethylene (20EO) C12-C15 alcohol | CRODA |
| Synperonic 13/8 | Polyoxyethylene (8EO) isotridecanol | CRODA |
| Synperonic 13/9 | Polyoxyethylene (9EO) isotridecanol | CRODA |
| Synperonic 13/10 | Polyoxyethylene (10EO) isotridecanol | CRODA |
| Synperonic 13/12 | Polyoxyethylene (12EO) tridecyl alcohol | CRODA |
| Synperonic 91/10 | Polyoxyethylene (10EO) C9-C11 alcohol | CRODA |
| Synperonic A3 | Polyoxyethylene (3EO) C12-C15 alcohol | CRODA |
| Synperonic A4 | Polyoxyethylene (4EO) C12-C15 alcohol | CRODA |
| Synperonic A7 | Polyoxyethylene (7EO) C12-C15 alcohol | CRODA |
| Synperonic A11 | Polyoxyethylene (11EO) C12-C15 alcohol | CRODA |
| Synperonic A20 | Polyoxyethylene (20EO) C12-C15 alcohol | CRODA |
| Cithrol 4ML | Polyethyleneglycol (8EO) monolaurate | CRODA |
| Cithrol 4MS | Polyethyleneglycol (8EO) monostearate | CRODA |
| Cithrol 6MS | Polyethyleneglycol (12EO) monostearate | CRODA |
| Cithrol 10MS | Polyethyleneglycol (20EO) monostearate | CRODA |
| Myrj S8 | Polyoxyethylene (8EO) stearate | CRODA |
| Myrj S20 | Polyoxyethylene (20EO) stearate | CRODA |
| Myrj S40 | Polyoxyethylene (40EO) stearate | CRODA |
| Myrj S50 | Polyoxyethylene (50EO) stearate | CRODA |
| Myrj S100 | Polyoxyethylene (100EO) stearate | CRODA |
| Emulsogen | Castor oil ethoxylate with 20 EO | Clariant |
| EL 200 | | |
| Emulsogen | Castor oil ethoxylate with 30 EO | Clariant |
| EL 300 LM | | |
| Emulsogen | Castor oil ethoxylate with 36 EO | Clariant |
| EL 360 | | |
| Emulsogen | Castor oil ethoxylate with 40 EO | Clariant |
| EL 400 | | |
| Emulsogen | Castor oil ethoxylate with 54 EO | Clariant |
| EL 540 | | |
| Crovol A70 | Polyoxyethylene (60EO) almond oil | CRODA |
| Crovol CR70G | Polyoxyethylene (60EO) rapeseed oil | CRODA |
| Crovol M70 | Polyoxyethylene (60EO) corn oil | CRODA |
| Crovol PK70 | Polyoxyethylene (45EO) palm kernel oil | CRODA |
| Solan 60 | Polyoxyethylene (60EO) lanolin | CRODA |
| Solan 75 | Polyoxyethylene (75EO) lanolin | CRODA |
| Synperonic | Polyalkylene oxide block copolymer | CRODA |
| PE/F 68 | | |

TABLE 2-4

| Trade name | Principal ingredient | Supplyer |
|---|---|---|
| Synperonic | Polyalkylene oxide block copolymer | CRODA |
| PE/F 87 | | |
| Synperonic | Polyalkylene oxide block copolymer | CRODA |
| PE/F 108 | | |
| Synperonic | Polyalkylene oxide block copolymer | CRODA |
| PE/F 127 | | |
| Synperonic | Polyalkylene oxide block copolymer | CRODA |
| PE/L 44 | | |
| Synperonic | Polyalkylene oxide block copolymer | CRODA |
| PE/L 64 | | |
| Synperonic | Polyalkylene oxide block copolymer | CRODA |
| PE/P 84 | | |
| Synperonic | Polyalkylene oxide block copolymer | CRODA |
| PE/P 105 | | |
| Synperonic | Alkoxylated ethylene diamine | CRODA |
| T/304 | | |
| Synperonic | Alkoxylated ethylene diamine | CRODA |
| T/905 | | |
| Synperonic | Alkoxylated ethylene diamine | CRODA |
| T/908 | | |
| STEP-FLOW | Polyalkylene oxide block copolymer | Stepan |
| 26 | | |
| STEP-FLOW | Polyalkylene oxide block copolymer | Stepan |
| LF | | |
| TOXIMUL | Polyalkylene oxide block copolymer | Stepan |
| 1-62 | | |
| TOXIMUL | Polyalkylene oxide block copolymer | Stepan |
| 8321 | | |
| TOXIMUL | Polyalkylene oxide block copolymer | Stepan |
| 8323 | | |
| Tween 20 | Polyoxyethylene (20EO) sorbitan monolaurate | CRODA |
| Tween 21 | Polyoxyethylene (4EO) sorbitan monolaurate | CRODA |
| Tween 40 | Polyoxyethylene (20EO) sorbitan monopalmitate | CRODA |
| Tween 60 | Polyoxyethylene (20EO) sorbitan monostearate | CRODA |
| Tween 61 | Polyoxyethylene (4EO) sorbitan monostearate | CRODA |
| Tween 65 | Polyoxyethylene (20EO) sorbitan tristearate | CRODA |
| Tween 80 | Polyoxyethylene (20EO) sorbitan monooleate | CRODA |
| Tween 81 | Polyoxyethylene (5EO) sorbitan monooleate | CRODA |
| Tween 85 | Polyoxyethylene (20EO) sorbitan trioleate | CRODA |
| Span 20 | Sorbitan monolaurate | CRODA |
| Arlatone TV | Polyoxyethylene (40EO) sorbitol oleate | CRODA |
| Atlas G-1086 | Polyoxyethylene (40EO) sorbitol hexaoleate | CRODA |
| Atlas G-1096 | Polyoxyethylene (50EO) sorbitol hexaoleate | CRODA |
| Atlox 1045A | Polyoxyethylene (30EO) sorbitol oleate-laurate | CRODA |
| Cirrasol | Polyoxyethylene (40EO) sorbitol hexaoleate | CRODA |
| G-1086 | | |
| Cirrasol | Polyoxyethylene (50EO) sorbitol hexaoleate | CRODA |
| G-1096 | | |
| Emulsogen M | Oleyl alcohol polyglycol ether | Clariant |

What is claimed is:

1. A liquid pesticidal composition comprising:
(a) a compound represented by the following formula (I);
(b) a solvent having a water solubility at 25° C. of 1 mass % or less;
(c) an ionic surfactant; and
(d) a nonionic surfactant. 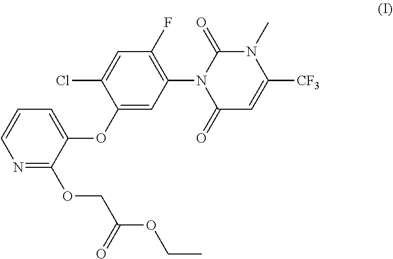 [SMILES: CCOC(=O)COc1ncccc1Oc1cc(-n2c(=O)cc(C(F)(F)F)n(C)c2=O)c(F)cc1Cl]
